(19) United States
(12) Patent Application Publication
(10) Pub. No.: US 2026/0340376 A1
(43) Pub. Date: Oct. 29, 2026

(54) DATA PROCESSING METHOD, APPARATUS AND SYSTEM FOR DISTRIBUTED CLUSTER, AND NONVOLATILE READABLE STORAGE MEDIUM

(71) Applicant: IEIT SYSTEMS CO., LTD., Jinan, Shandong (CN)

(72) Inventors: Kai GAO, Jinan, Shandong (CN); Zhenhua GUO, Jinan, Shandong (CN); Li WANG, Jinan, Shandong (CN); Fang CAO, Jinan, Shandong (CN); Yaqian ZHAO, Jinan, Shandong (CN); Yinan TANG, Jinan, Shandong (CN)

(21) Appl. No.: 19/116,987

(22) PCT Filed: Sep. 23, 2024
(86) PCT No.: PCT/CN2024/120459

§ 371 Date: Mar. 28, 2025

(30) Foreign Application Priority Data
Sep. 21, 2023 (CN) 202311221193.9

(51) Int. Cl. G06N 3/08; G06N 3/04

(52) U.S. Cl. CPC G06N 3/08; G06N 3/04

(57) ABSTRACT

The present application discloses a method, apparatus and system of data processing for a distributed cluster, and a non-volatile readable storage medium, applied in the technical field of artificial intelligence. In order to solve the problem of the poor current resource utilization ratio, a distributed cluster is provided that includes a plurality of accelerator-node groups that have accelerator nodes of multiple types, and each of the accelerator nodes is deployed with one network-layer sub-group of a neural network model. The method is applied in any one of the accelerator nodes of the accelerator-node groups, and includes grouping in advance the plurality of accelerator nodes of the distributed cluster, to obtain the plurality of accelerator-node groups; subsequently, regarding any one of the accelerator nodes, by using the network-layer sub-group deployed at a current accelerator node, calculating and processing a current to-be-processed datum, to obtain a current calculation result; and updating the current network parameter of the network-layer sub-group, to obtain respective updated network parameters of all of the network-layer sub-groups of the neural network model. The method has a high resource utilization ratio, and facilitates to increase the efficiency of the model parameter updating and realize a better power-consumption optimization.

### CROSS-REFERENCE TO RELATED APPLICATION

The present application claims the priority of the Chinese patent application filed on Sep. 21, 2023 before the Chinese Patent Office with the application number of 202311221193.9 and the title of “DATA PROCESSING METHOD, APPARATUS AND SYSTEM FOR DISTRIBUTED CLUSTER, AND NON-VOLATILE READABLE STORAGE MEDIUM”, which is incorporated herein in its entirety by reference.

### FIELD

The embodiments of the present application relate to the technical field of artificial intelligence, and particularly relate to a method, apparatus and system of data processing for a distributed cluster, and a non-volatile computer-readable storage medium.

### BACKGROUND

With the development of Artificial General Intelligence, the parameter quantity of deep-learning models grows exponentially, and increasingly more ultra-large-scale models emerge, which has a steadily increasing demand on the calculation power. Regarding the calculation architectures with CPUs (Central Processing Unit/Processor) as the center, even though multivariate heterogeneous calculation-power devices are continuously added and the single-node internal-memory capacity is expanded, the demands on the calculation power and the internal memory by applications still cannot be satisfied. Moreover, although the horizontal expansion of the nodes can process data of the TB level, because the storage and calculation resources are closely coupled, the calculation-power devices, the internal-memory expansibility and so on are restricted, and the characteristics of the hardware architectures such as multi-hierarchical internal-memory interconnection lack inside the nodes, inside the racks and between the racks of multivariate heterogeneous devices, the distributed computing systems formed by multiple nodes have a low performance.

Currently, the traditional large-scale-model deploying technique is usually deployed in a homogeneous system. The devices in the homogeneous system have the same performance, and therefore the division of the model is simple. However, with the increasing of the types of the computing devices, if the large-scale model is deployed merely in a homogeneous system, that results in waste of other computing devices. Furthermore, because, when the training of neural network models is performed by using the computing devices of a homogeneous system, the power consumption cannot be optimized well, that results in a high power consumption.

In view of the above, how to perform the deployment of a neural network model based on a distributed cluster, to enable the neural network model to be trained and reason in the distributed cluster with a high efficiency, is a problem that a person skilled in the art requires solving.

### SUMMARY

An object of the embodiments of the present application is to provide a method, apparatus and system of data processing for a distributed cluster, and a non-volatile computer-readable storage medium, which, in the usage, may increase the resource utilization ratio, to facilitate to increase the efficiency of the model parameter updating, and may provide more power-consumption optimizing strategies so as to perform power-consumption optimization better.

In order to solve the above technical problems, an embodiment of the present application provides a method of data processing for a distributed cluster, wherein the distributed cluster comprises a plurality of accelerator-node groups, each of the accelerator-node groups comprises accelerator nodes of multiple types, all of network layers of a neural network model are grouped into a plurality of network-layer sub-groups, each of the accelerator nodes is deployed with one instance of the network-layer sub-groups, and the method is applied in any one of the accelerator nodes of the accelerator-node groups, and comprises:
grouping in advance the plurality of accelerator nodes of the distributed cluster, to obtain the plurality of accelerator-node groups, wherein for all of the accelerator-node groups the types and connection-arrangement modes of the accelerator nodes and quantities of the accelerator nodes of the same type are the same, and to-be-processed data that are received by first accelerator nodes of all of the accelerator-node groups are different;
by using the network-layer sub-group deployed at a current accelerator node, calculating and processing a current to-be-processed datum, to obtain a current calculation result; and
based on the current calculation result, updating a current network parameter of the network-layer sub-group, to obtain an updated network parameter, to obtain respective updated network parameters of all of the network-layer sub-groups of the neural network model.

In an embodiment, the step of grouping in advance the plurality of accelerator nodes of the distributed cluster, to obtain the plurality of accelerator-node groups comprises:
dividing the accelerator nodes of each of the types of the distributed cluster individually evenly into a preset group quantity; and
regrouping the different types of accelerator nodes of the preset group quantity, to form the plurality of accelerator-node groups, wherein each of the accelerator-node groups comprises all of the types of accelerator nodes.

In an embodiment, before the step of dividing the accelerator nodes of each of the types of the distributed cluster individually evenly into the preset group quantity, the method further comprises:
based on a memory size occupied by the neural network model and a total memory size of all of the accelerator nodes of the distributed cluster, calculating to obtain the preset group quantity of the division.

In an embodiment, the step of, based on the memory size occupied by the neural network model and the total memory size of all of the accelerator nodes of the distributed cluster, calculating to obtain the preset group quantity of the division comprises:
acquiring the memory size occupied by the neural network model;
according to memory sizes of the accelerator nodes of the distributed cluster, calculating the total memory size of the accelerator nodes; and
dividing the total memory size by the memory size occupied by the neural network model, and rounding a quotient value, to obtain the preset group quantity.

In an embodiment, the method further comprises:
grouping in advance all of the network layers of the neural network model into a plurality of network-layer groups, wherein each of the network-layer groups comprises at least one instance of the network-layer sub-groups, and a quantity of the network-layer groups is equal to a quantity of the types of the accelerator nodes of each of the accelerator-node groups; and
for each of the accelerator-node groups, according to an arrangement sequence of the accelerator nodes of the multiple types, deploying sequentially the network-layer groups to the accelerator nodes of the multiple types, wherein each of the types of the accelerator nodes corresponds to one instance of the network-layer groups, and each of the accelerator nodes corresponds to one instance of the network-layer sub-groups.

In an embodiment, the step of grouping in advance all of the network layers of the neural network model into the plurality of network-layer groups comprises:
based on internal memories and calculation powers of the types of the accelerator nodes of the accelerator-node groups, grouping all of the network layers of the neural network model into the plurality of network-layer groups.

In an embodiment, layer quantities of the network-layer groups are in direct proportion to the internal memories and the calculation powers of the accelerator nodes of the corresponding types.

In an embodiment, the step of, according to the arrangement sequence of the accelerator nodes of the multiple types, deploying sequentially the network-layer groups to the accelerator nodes of the multiple types comprises:
for the accelerator nodes of an i-th type, dividing in advance a corresponding i-th network-layer group into the network-layer sub-groups of a quantity nᵢ, wherein the accelerator nodes of the i-th type include the accelerator nodes of the quantity nᵢ, wherein nᵢ is an integer greater than 1, wherein i∈[0, m−1], wherein m represents a quantity of the types of the accelerator nodes; and
deploying the network-layer sub-groups of the quantity nᵢ to the accelerator nodes of the quantity nᵢ, wherein the network-layer sub-groups of the quantity nᵢ correspond to the accelerator nodes of the quantity nᵢ one to one.

In an embodiment, the step of dividing in advance the corresponding i-th network-layer group into the network-layer sub-groups of the quantity nᵢ comprises:
according to the accelerator nodes of the i-th type corresponding to the i-th network-layer group, enumerating network-layer-group grouping strategies of multiple types;
for each of the types of the network-layer-group grouping strategies, calculating a corresponding execution duration of the network-layer-group grouping strategy in data processing;
based on the execution durations corresponding to the network-layer-group grouping strategies individually, screening the network-layer-group grouping strategy the execution duration of which is lowest; and
dividing the i-th network-layer group by using the network-layer-group grouping strategy the execution duration of which is lowest, to obtain the network-layer sub-groups of the quantity nᵢ.

In an embodiment, the step of, based on the current calculation result, updating the current network parameter of the network-layer sub-group, to obtain the updated network parameter, to obtain the respective updated network parameters of all of the network-layer sub-groups of the neural network model comprises:
based on the current calculation result, updating the current network parameter of the network-layer sub-group, to obtain the updated network parameter;
in response to the current accelerator node being a last one node, obtaining the respective updated network parameters of the network-layer sub-groups of the neural network model; and
in response to the current accelerator node being not a last one node, sending the current calculation result to the accelerator node corresponding to the next one instance of the network-layer sub-groups, using the accelerator node corresponding to the next one network-layer sub-group as the current accelerator node, and returning to execute the step of, by using the network-layer sub-group deployed at the current accelerator node, calculating and processing the current to-be-processed datum.

In an embodiment, the step of, in response to the current accelerator node being not the last one node, sending the current calculation result to the accelerator node corresponding to the next one instance of the network-layer sub-groups comprises:
in response to the current accelerator node being not the last one node, determining whether the current accelerator node and the accelerator node corresponding to the next one network-layer sub-group are accelerator nodes of a same type;
in response to the current accelerator node and the accelerator node corresponding to the next one network-layer sub-group being accelerator nodes of the same type, in a mode of tensor parallelism, sending the current calculation result to the accelerator node corresponding to the next one network-layer sub-group; and
in response to the current accelerator node and the accelerator node corresponding to the next one network-layer sub-group being not accelerator nodes of the same type, in a mode of pipelined parallelism, sending the current calculation result to the accelerator node corresponding to the next one network-layer sub-group.

In an embodiment, after the step of, based on the current calculation result, updating the current network parameter of the network-layer sub-group, to obtain the updated network parameter, the method further comprises:
receiving the updated network parameters sent by other accelerator nodes corresponding to the network-layer sub-group in other instances of the accelerator-node groups;
based on the updated network parameters sent by the other accelerator nodes, adjusting the updated network parameter corresponding to the current accelerator node; and
sending the updated network parameter corresponding to the current accelerator node to target accelerator nodes corresponding to the network-layer sub-group in the other accelerator-node groups, whereby the target accelerator nodes, based on the updated network parameter corresponding to the current accelerator node, adjusts the updated network parameters of corresponding network-layer sub-groups.

In an embodiment, a total quantity of the accelerator nodes of a same type as a type of the current accelerator node in the accelerator-node group where the current accelerator node is located is at least 2; and
the step of sending the updated network parameter corresponding to the current accelerator node to the target accelerator nodes corresponding to the network-layer sub-group in the other accelerator-node groups comprises:
in response to the current accelerator node being a master accelerator node, acquiring the updated network parameter that is returned from a slave accelerator node of the same type as the type of the current accelerator node in the accelerator-node group where the current accelerator node is located, to obtain an updated-parameter set; and
sending the updated-parameter set to target master accelerator nodes corresponding to the network-layer sub-group in the other accelerator-node groups.

In an embodiment, the step of receiving the updated network parameters sent by the other accelerator nodes corresponding to the network-layer sub-group in the other instances of the accelerator-node groups comprises:
in response to the current accelerator node being a master accelerator node, receiving the updated-parameter sets sent by other master accelerator nodes corresponding to the network-layer sub-group in the other accelerator-node groups; and
the step of, based on the updated network parameters sent by the other accelerator nodes, adjusting the updated network parameter corresponding to the current accelerator node comprises:
based on the updated-parameter sets sent by the other master accelerator nodes, adjusting the updated network parameter corresponding to the current accelerator node, to obtain a network parameter that has been adjusted.

In an embodiment, the step of, based on the updated-parameter sets sent by the other master accelerator nodes, adjusting the updated network parameter corresponding to the current accelerator node, to obtain the network parameter that has been adjusted comprises:
based on the updated-parameter sets sent by the other master accelerator nodes, determining parameter sets corresponding individually to the network layers of the network-layer sub-group in the current accelerator node; and
for each of the network layers, based on the parameter set corresponding to the network layer, calculating a parameter average-value, and using the parameter average-value as the network parameter that has been adjusted corresponding to the network layer.

In an embodiment, after the step of receiving the updated-parameter sets sent by the other master accelerator nodes corresponding to the network-layer sub-group in the other accelerator-node groups, the method further comprises:
among the updated-parameter sets sent by the other master accelerator nodes, determining an updated target parameter set corresponding to a slave accelerator node of the same type in the accelerator-node group where the current accelerator node is located; and
sending the updated target parameter set to the corresponding slave accelerator node, whereby the slave accelerator node, according to the updated target parameter set, adjusts the updated network parameter in the slave accelerator node.

In an embodiment, a total quantity of the accelerator nodes of a same type as a type of the current accelerator node in the accelerator-node group where the current accelerator node is located is at least 2; and
the step of sending the updated network parameter corresponding to the current accelerator node to the target accelerator nodes corresponding to the network-layer sub-group in the other accelerator-node groups comprises:
in response to the current accelerator node being a slave accelerator node, sending the updated network parameter corresponding to the current accelerator node to a master accelerator node corresponding to the current accelerator node in the accelerator-node group where the current accelerator node is located, whereby the master accelerator node, based on the updated network parameter corresponding to the current accelerator node, obtains the updated-parameter set, and sends the updated-parameter set to target master accelerator nodes corresponding to the network-layer sub-group in the other accelerator-node groups.

In an embodiment, the step of receiving the updated network parameters sent by the other accelerator nodes corresponding to the network-layer sub-group in the other instances of the accelerator-node groups comprises:
in response to the current accelerator node being a slave accelerator node, receiving the updated target parameter set sent by the master accelerator node corresponding to the current accelerator node, wherein the updated target parameter set is obtained by the master accelerator node according to the updated-parameter sets sent by other master accelerator nodes corresponding to the network-layer sub-group in the other accelerator-node groups; and
based on the updated target parameter set, adjusting the updated network parameters of the network layers in the network-layer sub-group in the current accelerator node, to obtain network parameters that have been adjusted.

In an embodiment, the step of, based on the updated target parameter set, adjusting the updated network parameters of the network layers in the network-layer sub-group in the current accelerator node, to obtain the network parameters that have been adjusted comprises:
based on the updated target parameter set, determining parameter sets corresponding individually to the network layers of the network-layer sub-group in the current accelerator node; and
for each of the network layers, based on the parameter set corresponding to the network layer, calculating a parameter average-value, and using the parameter average-value as the network parameter that has been adjusted corresponding to the network layer.

An embodiment of the present application further provides an apparatus of data processing for a distributed cluster, wherein the distributed cluster comprises a plurality of accelerator-node groups, each of the accelerator-node groups comprises accelerator nodes of multiple types, all of network layers of a neural network model are grouped into a plurality of network-layer sub-groups, each of the accelerator nodes is deployed with one instance of the network-layer sub-groups, and the apparatus is applied in any one of the accelerator nodes of the accelerator-node groups, and comprises:
a first grouping module configured for grouping in advance the plurality of accelerator nodes of the distributed cluster, to obtain the plurality of accelerator-node groups, wherein for all of the accelerator-node groups the types and connection-arrangement modes of the accelerator nodes and quantities of the accelerator nodes of the same type are the same, and to-be-processed data that are received by first accelerator nodes of all of the accelerator-node groups are different;
a first calculating module configured for, by using the network-layer sub-group deployed at a current accelerator node, calculating and processing a current to-be-processed datum, to obtain a current calculation result; and
an updating module configured for, based on the current calculation result, updating a current network parameter of the network-layer sub-group, to obtain an updated network parameter, to obtain respective updated network parameters of all of the network-layer sub-groups of the neural network model.

In an embodiment, the first grouping module comprises:
a first grouping unit configured for dividing the accelerator nodes of each of the types of the distributed cluster individually evenly into a preset group quantity; and
a regrouping unit configured for regrouping the different types of accelerator nodes of the preset group quantity, to form the plurality of accelerator-node groups, wherein each of the accelerator-node groups comprises all of the types of accelerator nodes.

In an embodiment, the apparatus further comprises:
a first calculating unit configured for, based on a memory size occupied by the neural network model and a total memory size of all of the accelerator nodes of the distributed cluster, calculating to obtain the preset group quantity of the division.

In an embodiment, the first calculating unit comprises:
a first acquiring subunit configured for acquiring the memory size occupied by the neural network model;
a first calculating subunit configured for, according to memory sizes of the accelerator nodes of the distributed cluster, calculating the total memory size of the accelerator nodes; and
a second calculating subunit configured for dividing the total memory size by the memory size occupied by the neural network model, and rounding a quotient value, to obtain the preset group quantity.

In an embodiment, the apparatus further comprises:
a second grouping module configured for grouping in advance all of the network layers of the neural network model into a plurality of network-layer groups, wherein each of the network-layer groups comprises at least one instance of the network-layer sub-groups, and a quantity of the network-layer groups is equal to a quantity of the types of the accelerator nodes of each of the accelerator-node groups; and
a deploying module configured for, for each of the accelerator-node groups, according to an arrangement sequence of the accelerator nodes of the multiple types, deploying sequentially the network-layer groups to the accelerator nodes of the multiple types, wherein each of the types of the accelerator nodes corresponds to one instance of the network-layer groups, and each of the accelerator nodes corresponds to one instance of the network-layer sub-groups.

In an embodiment, the second grouping module is configured for:
based on internal memories and calculation powers of the types of the accelerator nodes of the accelerator-node groups, grouping all of the network layers of the neural network model into the plurality of network-layer groups.

In an embodiment, layer quantities of the network-layer groups are in direct proportion to the internal memories and the calculation powers of the accelerator nodes of the corresponding types.

In an embodiment, the deploying module comprises:
a second grouping unit configured for, for the accelerator nodes of an i-th type, dividing in advance a corresponding i-th network-layer group into the network-layer sub-groups of a quantity nᵢ, wherein the accelerator nodes of the i-th type include the accelerator nodes of the quantity nᵢ, wherein nᵢ is an integer greater than 1, wherein i∈[0, m−1], wherein m represents a quantity of the types of the accelerator nodes; and
a deploying unit configured for deploying the network-layer sub-groups of the quantity nᵢ to the accelerator nodes of the quantity nᵢ, wherein the network-layer sub-groups of the quantity nᵢ correspond to the accelerator nodes of the quantity nᵢ one to one.

In an embodiment, the second grouping unit comprises:
a strategy generating subunit configured for, according to the accelerator nodes of the i-th type corresponding to the i-th network-layer group, enumerating network-layer-group grouping strategies of multiple types;
a third calculating subunit configured for, for each of the types of the network-layer-group grouping strategies, calculating a corresponding execution duration of the network-layer-group grouping strategy in data processing;
a screening subunit configured for, based on the execution durations corresponding to the network-layer-group grouping strategies individually, screening the network-layer-group grouping strategy the execution duration of which is lowest; and
a dividing subunit configured for dividing the i-th network-layer group by using the network-layer-group grouping strategy the execution duration of which is lowest, to obtain the network-layer sub-groups of the quantity nᵢ.

In an embodiment, the updating module comprises:
an updating unit configured for, based on the current calculation result, updating the current network parameter of the network-layer sub-group, to obtain the updated network parameter;
a deciding unit configured for, in response to the current accelerator node being a last one node, obtaining the respective updated network parameters of the network-layer sub-groups of the neural network model; and
a first sending unit configured for, in response to the current accelerator node being not a last one node, sending the current calculation result to the accelerator node corresponding to the next one instance of the network-layer sub-groups, using the accelerator node corresponding to the next one network-layer sub-group as the current accelerator node, and returning to execute the step of, by using the network-layer sub-group deployed at the current accelerator node, calculating and processing the current to-be-processed datum.

In an embodiment, the first sending unit comprises:
a judging subunit configured for, if the accelerator node is not the last one node, determining whether the accelerator node and the accelerator node corresponding to the next one network layer are accelerator nodes of the same type; if the accelerator node and the accelerator node corresponding to the next one network layer are accelerator nodes of the same type, triggering a first sending subunit; and if the accelerator node and the accelerator node corresponding to the next one network layer are not accelerator nodes of the same type, triggering a second sending subunit;
the first sending subunit is configured for, in a mode of tensor parallelism, sending the current calculation result to the accelerator node corresponding to the next one network layer; and
the second sending subunit is configured for, in a mode of pipelined parallelism, sending the current calculation result to the accelerator node corresponding to the next one network layer.

In an embodiment, the apparatus further comprises:
a receiving module configured for receiving the updated network parameters sent by other accelerator nodes corresponding to the network-layer sub-group in other instances of the accelerator-node groups;
a first adjusting module configured for, based on the updated network parameters sent by the other accelerator nodes, adjusting the updated network parameter corresponding to the current accelerator node; and
a first sending module configured for sending the updated network parameter corresponding to the current accelerator node to target accelerator nodes corresponding to the network-layer sub-group in the other accelerator-node groups, whereby the target accelerator nodes, based on the updated network parameter corresponding to the current accelerator node, adjusts the updated network parameters of corresponding network-layer sub-groups.

In an embodiment, a total quantity of the accelerator nodes of a same type as a type of the current accelerator node in the accelerator-node group where the current accelerator node is located is at least 2; and
the first sending module comprises:
a first acquiring unit configured for, in response to the current accelerator node being a master accelerator node, acquiring the updated network parameter that is returned from a slave accelerator node of the same type as the type of the current accelerator node in the accelerator-node group where the current accelerator node is located, to obtain an updated-parameter set; and
a second sending unit configured for sending the updated-parameter set to target master accelerator nodes corresponding to the network-layer sub-group in the other accelerator-node groups.

In an embodiment, the receiving module comprises:
a first receiving subunit configured for, in response to the current accelerator node being a master accelerator node, receiving the updated-parameter sets sent by other master accelerator nodes corresponding to the network-layer sub-group in the other accelerator-node groups; and
the first adjusting module is configured for:
based on the updated-parameter sets sent by the other master accelerator nodes, adjusting the updated network parameter corresponding to the current accelerator node, to obtain a network parameter that has been adjusted.

In an embodiment, the first adjusting module comprises:
a first determining unit configured for, based on the updated-parameter sets sent by the other master accelerator nodes, determining parameter sets corresponding individually to the network layers of the network-layer sub-group in the current accelerator node; and
a second calculating unit configured for, for each of the network layers, based on the parameter set corresponding to the network layer, calculating a parameter average-value, and using the parameter average-value as the network parameter that has been adjusted corresponding to the network layer.

In an embodiment, the apparatus further comprises:
a second determining unit configured for, among the updated-parameter sets sent by the other master accelerator nodes, determining an updated target parameter set corresponding to a slave accelerator node of the same type in the accelerator-node group where the current accelerator node is located; and
a third sending unit configured for sending the updated target parameter set to the corresponding slave accelerator node, whereby the slave accelerator node, according to the updated target parameter set, adjusts the updated network parameter in the slave accelerator node.

In an embodiment, a total quantity of the accelerator nodes of a same type as a type of the current accelerator node in the accelerator-node group where the current accelerator node is located is at least 2; and
the first sending module is configured for:
in response to the current accelerator node being a slave accelerator node, sending the updated network parameter corresponding to the current accelerator node to a master accelerator node corresponding to the current accelerator node in the accelerator-node group where the current accelerator node is located, whereby the master accelerator node, based on the updated network parameter corresponding to the current accelerator node, obtains the updated-parameter set, and sends the updated-parameter set to target master accelerator nodes corresponding to the network-layer sub-group in the other accelerator-node groups.

In an embodiment, the receiving module comprises:
a second receiving unit configured for, in response to the current accelerator node being a slave accelerator node, receiving the updated target parameter set sent by the master accelerator node corresponding to the current accelerator node, wherein the updated target parameter set is obtained by the master accelerator node according to the updated-parameter sets sent by other master accelerator nodes corresponding to the network-layer sub-group in the other accelerator-node groups; and
an adjusting unit configured for, based on the updated target parameter set, adjusting the updated network parameters of the network layers in the network-layer sub-group in the current accelerator node, to obtain network parameters that have been adjusted.

In an embodiment, the adjusting unit comprises:
a determining subunit configured for, based on the updated target parameter set,
determining parameter sets corresponding individually to the network layers of the network-layer sub-group in the current accelerator node; and
a fourth calculating subunit configured for, for each of the network layers, based on the parameter set corresponding to the network layer, calculating a parameter average-value, and using the parameter average-value as the network parameter that has been adjusted corresponding to the network layer.

An embodiment of the present application further provides a system of data processing for a distributed cluster, wherein the distributed cluster comprises a plurality of accelerator-node groups, each of the accelerator-node groups comprises accelerator nodes of multiple types, all of network layers of a neural network model are grouped into a plurality of network-layer sub-groups, each of the accelerator nodes is deployed with one instance of the network-layer sub-groups, and any one of the accelerator nodes comprises:
a memory configured for storing a computer program; and
a processor configured for, when executing the computer program, implementing the steps of the method of data processing for a distributed cluster described above.

An embodiment of the present application further provides a non-volatile computer-readable storage medium, wherein the non-volatile computer-readable storage medium stores a computer program, and the computer program, when executed by a processor, implements the steps of the method of data processing for a distributed cluster described above.

The embodiments of the present application provide a method, apparatus and system of data processing for a distributed cluster, and a non-volatile computer-readable storage medium, wherein the distributed cluster comprises a plurality of accelerator-node groups, each of the accelerator-node groups comprises accelerator nodes of multiple types, all of network layers of a neural network model are grouped into a plurality of network-layer sub-groups, each of the accelerator nodes is deployed with one instance of the network-layer sub-groups, and the method is applied in any one of the accelerator nodes of the accelerator-node groups, and comprises: grouping in advance the plurality of accelerator nodes of the distributed cluster, to obtain the plurality of accelerator-node groups, wherein for all of the accelerator-node groups the types and connection-arrangement modes of the accelerator nodes and quantities of the accelerator nodes of the same type are the same, and to-be-processed data that are received by first accelerator nodes of all of the accelerator-node groups are different; by using the network-layer sub-group deployed at a current accelerator node, calculating and processing a current to-be-processed datum, to obtain a current calculation result; and based on the current calculation result, updating a current network parameter of the network-layer sub-group, to obtain an updated network parameter, to obtain respective updated network parameters of all of the network-layer sub-groups of the neural network model.

It can be seen that, in the embodiments of the present application, the distributed cluster comprises a plurality of accelerator-node groups, each of the accelerator-node groups comprises accelerator nodes of multiple types, all of the network layers of a neural network model are grouped into network-layer sub-groups, each of the accelerator nodes is deployed with one network-layer sub-group, for all of the accelerator-node groups the types and the connection-arrangement modes of the accelerator nodes and the quantities of the accelerator nodes of the same type are the same, and the to-be-processed data that are received by the first accelerator nodes of all of the accelerator-node groups are different. In the present application, the neural network model may be deployed in the accelerator nodes of the different types, and the plurality of accelerator-node groups may concurrently execute the calculation and processing of data. The different accelerator nodes of multiple types and the network-layer sub-groups deployed in the accelerator nodes may be utilized to perform the network-parameter updating of a pre-trained language network, which may increase the resource utilization ratio, to facilitate to increase the efficiency of the model parameter updating, and may provide more power-consumption optimizing strategies so as to perform power-consumption optimization better.

### BRIEF DESCRIPTION OF THE DRAWINGS

In order to more clearly illustrate the technical solutions of the embodiments of the present application, the figures that are required to describe the related art and the embodiments will be briefly described below. Apparently, the figures that are described below are merely embodiments of the present application, and a person skilled in the art can obtain other figures according to these figures without paying creative work.

FIG. 1 is a schematic flow chart of a method of data processing for a distributed cluster according to an embodiment of the present application;

FIG. 2 is a schematic diagram of the deployment of the network-layer sub-groups of a neural network model according to an embodiment of the present application;

FIG. 3 is a schematic structural diagram of a plurality of accelerator-node groups according to an embodiment of the present application;

FIG. 4 is a schematic diagram of a grouping process of a plurality of accelerator nodes of a distributed cluster according to an embodiment of the present application;

FIG. 5 is a schematic diagram of the deployment of the network-layer groups of a neural network model according to an embodiment of the present application;

FIG. 6 is a schematic diagram of the pipelined parallelism of the accelerator nodes of different types and the tensor parallelism of the accelerator nodes of the same types according to an embodiment of the present application;

FIG. 7 is a schematic diagram of the pipelined execution of calculation and communication according to an embodiment of the present application;

FIG. 8 is a schematic diagram of the data parallelism between the accelerator-node groups according to an embodiment of the present application;

FIG. 9 is a schematic diagram of the phased parameter updating according to an embodiment of the present application;

FIG. 10 is a schematic diagram of the grouped aggregation and parallel communication between the accelerator-node groups according to an embodiment of the present application;

FIG. 11 is a schematic diagram of the communication between the master accelerator nodes of the same type of the different accelerator-node groups according to an embodiment of the present application;

FIG. 12 is a schematic structural diagram of an apparatus of data processing for a distributed cluster according to an embodiment of the present application;

FIG. 13 is a schematic structural diagram of an accelerator node according to an embodiment of the present application; and

FIG. 14 is a schematic structural diagram of a non-volatile computer-readable storage medium according to an embodiment of the present application.

### DETAILED DESCRIPTION

The embodiments of the present application provide a method, apparatus and system of data processing for a distributed cluster, and a non-volatile computer-readable storage medium, which, in the usage, may increase the resource utilization ratio, to facilitate to increase the efficiency of the model parameter updating, and may provide more power-consumption optimizing strategies so as to perform power-consumption optimization better.

In order to make the objects, the technical solutions and the advantages of the embodiments of the present application clearer, the technical solutions according to the embodiments of the present application will be clearly and completely described below with reference to the drawings according to the embodiments of the present application. Apparently, the described embodiments are merely certain embodiments of the present application, rather than all of the embodiments. All of the other embodiments that a person skilled in the art obtains on the basis of the embodiments of the present application without paying creative work fall within the protection scope of the present application.

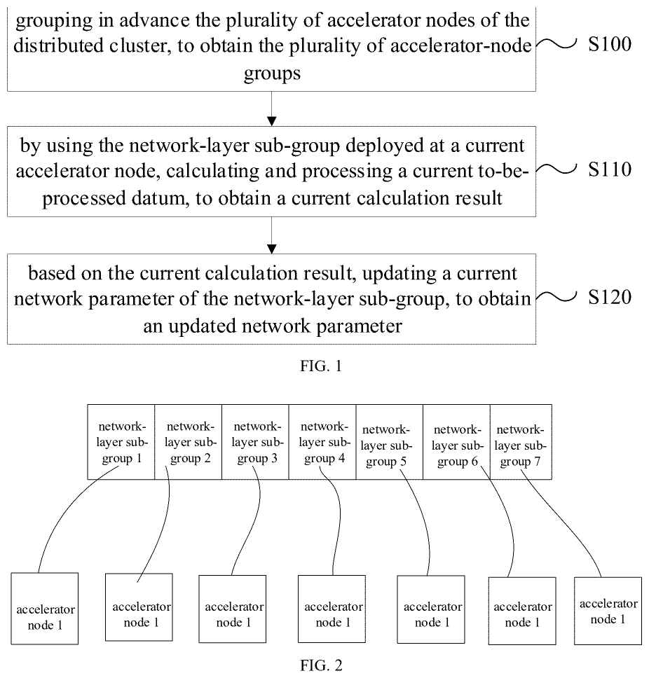

Referring to FIG. 1, FIG. 1 is a schematic flow chart of a method of data processing for a distributed cluster according to an embodiment of the present application. In the embodiments of the present application, the distributed cluster comprises a plurality of accelerator-node groups, each of the accelerator-node groups comprises accelerator nodes of multiple types, all of network layers of a neural network model are grouped into a plurality of network-layer sub-groups, and each of the accelerator nodes is deployed with one network-layer sub-group.

It should be noted that, in the embodiments of the present application, the accelerator nodes of multiple types in each of the plurality of accelerator-node groups of the distributed cluster are utilized to perform the deployment of the neural network model and the updating of the network parameters, and the network-layer sub-groups of all of the network layers of the neural network model may be deployed in all of the accelerator nodes, whereby each of the accelerator nodes is deployed with one network-layer sub-group, as shown in FIG. 2. The accelerator nodes of multiple types according to the embodiments of the present application may serve as a multivariate heterogeneous device.

The method is applied in any one of the accelerator nodes of the accelerator-node groups, and comprises:

S100: grouping in advance the plurality of accelerator nodes of the distributed cluster, to obtain the plurality of accelerator-node groups, wherein for all of the accelerator-node groups the types and connection-arrangement modes of the accelerator nodes and quantities of the accelerator nodes of the same type are the same, and to-be-processed data that are received by first accelerator nodes of all of the accelerator-node groups are different.

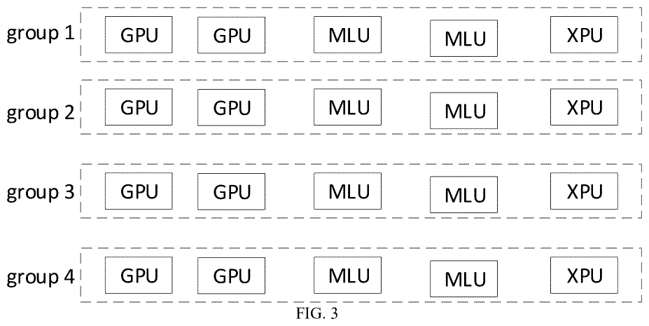

It should be noted that, in the embodiments of the present application, the plurality of accelerator nodes of the distributed cluster may be grouped in advance, to group the plurality of accelerator nodes into a plurality of accelerator-node groups, each of the accelerator-node groups comprises accelerator nodes of multiple types, the quantities of the accelerator nodes of the same type are equal, and the connection-arrangement modes of the accelerator nodes are the same. In practical applications, the accelerator nodes may include a GPU (Graphics Processing Unit), an MLU (Machine Learning Unit) or an XPU (extensible Processing Unit). As shown in FIG. 3, each of the accelerator-node groups comprises two GPUs, two MLUs and one XPU, and the connection-arrangement mode of the accelerator nodes is that the GPU, the GPU, the MLU, the MLU and the XPU are sequentially interconnected, whereby the data may be inputted via the GPU and the final result may be outputted from the XPU. In some embodiments, each of the accelerator-node groups is deployed with one complete neural network model (for example, a pre-trained language model). In other words, regarding any one of the accelerator-node groups, the network-layer sub-groups of the neural network model are deployed in the accelerator nodes of the accelerator-node groups individually, and the to-be-processed data that are received by the accelerator-nodes that are configured for deploying the first network-layer sub-groups in the accelerator-node groups are different. Therefore, each of the accelerator-node groups may simultaneously perform batch processing to different training data, so as to increase the efficiency of the network-parameter updating, i.e., increase the efficiency of the training of the neural network models.

In practical applications, this grouping step may be executed by any one of the accelerator nodes of the distributed cluster, or this grouping step may be executed by a third-party server, which may be decided according to practical situations, and is not particularly limited in the embodiments of the present application.

S110: by using the network-layer sub-group deployed at a current accelerator node, calculating and processing a current to-be-processed datum, to obtain a current calculation result.

It should be noted that, in the embodiments of the present application, any one of the accelerator nodes of the accelerator-node groups is referred to as the current accelerator node. After the current accelerator node has received the current to-be-processed datum, the current to-be-processed datum is calculated and processed by using the network-layer sub-group deployed at the current accelerator node, to obtain the corresponding current calculation result.

S120: based on the current calculation result, updating a current network parameter of the network-layer sub-group, to obtain an updated network parameter, to obtain respective updated network parameters of all of the network-layer sub-groups of the neural network model.

In some embodiments, the current accelerator node, after obtaining the current calculation result, according to the current calculation result, updates the current network parameter of the network-layer sub-group deployed at the current accelerator node, and obtains the updated network parameter of the network-layer sub-group. Each of the accelerator nodes performs the calculation and processing according to the current to-be-processed datum of itself, to obtain the corresponding current calculation result. Subsequently, each of all of the accelerator nodes, according to the current calculation result corresponding to itself, updates the current network parameter of the network-layer sub-group deployed at itself, whereby the respective updated network parameters of the network-layer sub-groups of the neural network model can be obtained.

It can be seen that, in the embodiments of the present application, the distributed cluster comprises a plurality of accelerator-node groups, each of the accelerator-node groups comprises accelerator nodes of multiple types, all of the network layers of a neural network model are grouped into network-layer sub-groups, each of the accelerator nodes is deployed with one network-layer sub-group, for all of the accelerator-node groups the types and the connection-arrangement modes of the accelerator nodes and the quantities of the accelerator nodes of the same type are the same, and the to-be-processed data that are received by the first accelerator nodes of all of the accelerator-node groups are different. In the present application, the neural network model may be deployed in the accelerator nodes of the different types, and the plurality of accelerator-node groups may concurrently execute the calculation and processing of data. The different accelerator nodes of multiple types and the network-layer sub-groups deployed in the accelerator nodes may be utilized to perform the network-parameter updating of a pre-trained language network, which may increase the resource utilization ratio, to facilitate to increase the efficiency of the model parameter updating, and may provide more power-consumption optimizing strategies so as to perform power-consumption optimization better.

It should be noted that, because in the distributed cluster exist different heterogeneous accelerator nodes of multiple types, and the various accelerator nodes differ hugely in the performances, the traditional device grouping is no longer applicable. Because of the uniqueness of each of the types of accelerator nodes, usually each of the types of accelerator nodes is grouped into one group, which causes that the accelerator nodes of the groups have huge differences therebetween, and, in concurrent data training, the data cannot be collectively allocated. In order to solve the above problem, the embodiments of the present application provide a novel strategy of dividing and regrouping the accelerator nodes, in which firstly the devices of the same type are divided, and subsequently the devices of the different types are regrouped.

In other words, the step of grouping in advance the plurality of accelerator nodes of the distributed cluster, to obtain the plurality of accelerator-node groups may comprise:
dividing the accelerator nodes of each of the types of the distributed cluster individually evenly into a preset group quantity; and
regrouping the different types of accelerator nodes of the preset group quantity, to form the plurality of accelerator-node groups, wherein each of the accelerator-node groups comprises all of the types of accelerator nodes.

It should be noted that the distributed cluster has accelerator nodes of multiple types, and the quantity of the accelerator nodes of each of the types may be one, and may also be plural. In practical applications, the accelerator nodes of each of the types of the distributed cluster may be firstly grouped, which may comprise, regarding any one of the types of accelerator nodes, according to the quantity of the accelerator nodes of that type, dividing the accelerator nodes of that type evenly into a preset group quantity, wherein the preset group quantity may be obtained by calculation according to a memory size occupied by the neural network model and a total memory size of all of the accelerator nodes of the distributed cluster. Subsequently, from the types of the accelerator nodes, the accelerator nodes of the different types and of the preset group quantity are regrouped, so that each of the accelerator-node groups that are obtained after the regrouping comprises the various accelerator nodes. The accelerator-node groups according to the embodiments of the present application have the same performances.

Further, the step of, based on the memory size occupied by the neural network model and the total memory size of all of the accelerator nodes of the distributed cluster, calculating to obtain the preset group quantity of the division may comprise:
acquiring the memory size occupied by the neural network model;
according to memory sizes of the accelerator nodes of the distributed cluster, calculating the total memory size of the accelerator nodes; and
dividing the total memory size by the memory size occupied by the neural network model, and rounding a quotient value, to obtain the preset group quantity.

It can be understood that, in the embodiments of the present application, the method may comprise acquiring the memory size occupied by the corresponding neural network model, calculating the total memory size of all of the accelerator nodes of the distributed cluster, subsequently dividing the total memory size by the memory size occupied by the neural network model to obtain the corresponding quotient value, subsequently rounding the quotient value to obtain the preset group quantity, and subsequently dividing and regrouping each of the types of the accelerator nodes of the distributed cluster according to the preset group quantity, to obtain the accelerator-node groups.

For example, the distributed cluster has the accelerator nodes of m types {0,1,2, . . . ,m−1}, and the quantity of the accelerator nodes of the i-th type is nᵢ; in other words, the set of the quantities of the accelerator nodes of all of the types is {n₀, n₁, . . . , nᵢ, . . . ,nₘ₋₁}. Assuming that the memory size of each of the accelerator nodes of the i-th type is sᵢ, and the total internal memory occupied by the neural network model is S, then the accelerator nodes may be grouped in the following manner:
The sum of the internal memories of the accelerator nodes of the distributed cluster is calculated according to a first calculation relation, to obtain the total memory size T, wherein the first calculation relation is:

$$T = {\sum }_{i = 0}^{m - 1} {n}_{i} * {s}_{i} .$$

Subsequently, the preset group quantity z is calculated. In some embodiments, according to a second calculation relation, the total memory size T is divided by the internal memory S occupied by the neural network model, to obtain the corresponding quotient value, and, subsequently, by rounding the quotient value, the preset group quantity z can be obtained. The second calculation relation is z₀=T/S, and subsequently z₀ is rounded to obtain z.

In some embodiments, the accelerator nodes of the different types are individually grouped into z groups, and subsequently the corresponding groups are regrouped into new groups, to obtain the accelerator-node groups. Therefore, the node performances of the accelerator-node groups may be equalized, in data parallelism the data may be divided evenly into a plurality of data segments, and the accelerator-node groups have the same training performances, which may reduce mutual waiting between the groups, to increase the overall efficiency.

For example, in an embodiment, m is 4, and z=4. The situation of the grouping is shown in FIG. 4, wherein the GPUs are grouped into 4 groups, the MLUs are grouped into 4 groups, and the XPUs are grouped into 4 groups. Subsequently, the corresponding groups are regrouped. For example, the first group of the GPUs, the first group of the MLUs and the first group of the XPUs are regrouped, to obtain the first accelerator-node group: GPU, GPU, MLU, MLU and XPU, and the other groups are regrouped by using the same method, whereby 4 same accelerator-node groups can be obtained: GPU, GPU, MLU, MLU and XPU.

In an embodiment, the method further comprises:
grouping in advance all of the network layers of the neural network model into a plurality of network-layer groups, wherein each of the network-layer groups comprises at least one instance of the network-layer sub-groups, and a quantity of the network-layer groups is equal to a quantity of the types of the accelerator nodes of each of the accelerator-node groups; and
for each of the accelerator-node groups, according to an arrangement sequence of the accelerator nodes of the multiple types, deploying sequentially the network-layer groups to the accelerator nodes of the multiple types, wherein each of the types of the accelerator nodes corresponds to one instance of the network-layer groups, and each of the accelerator nodes corresponds to one instance of the network-layer sub-groups.

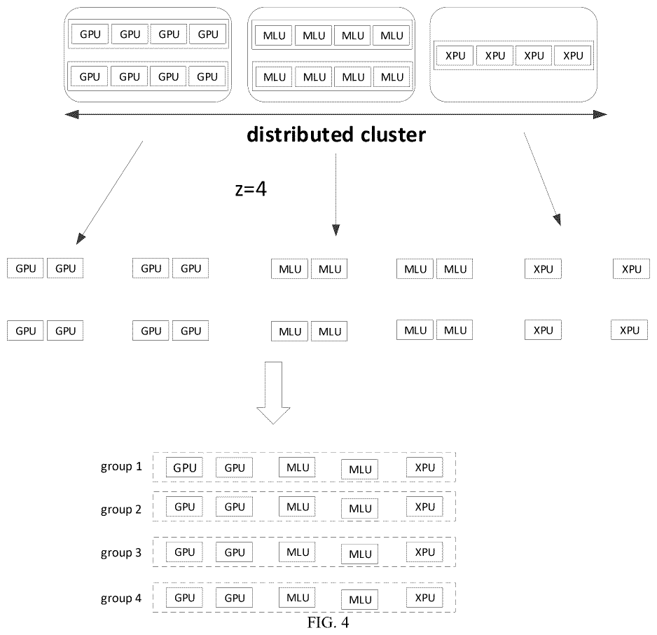

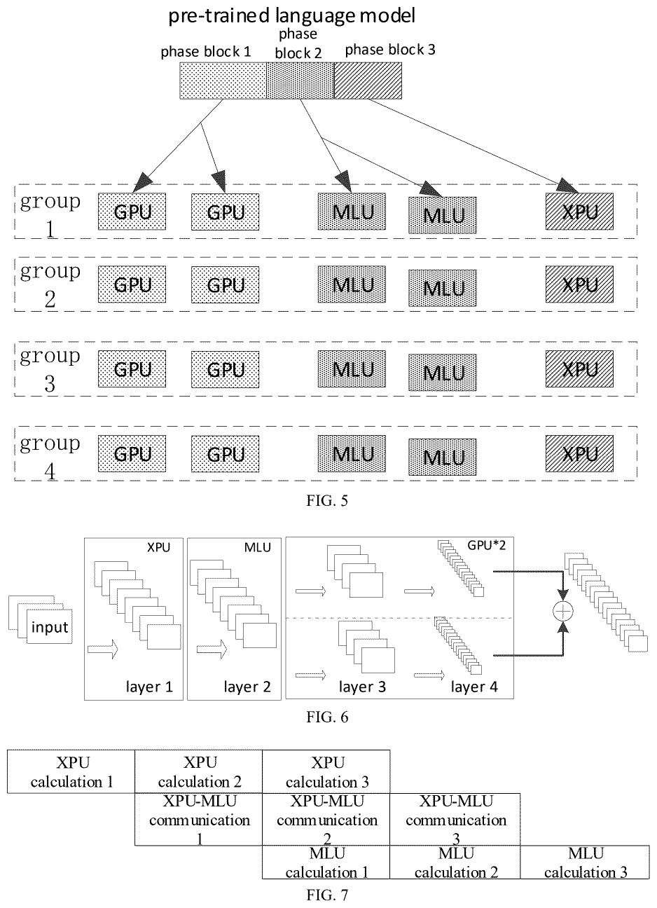

It should be noted that, in practical applications, the method may comprise, according to the quantity of the types of the accelerator nodes in each of the accelerator-node groups of the distributed cluster, grouping in advance all of the network layers of the neural network model into a plurality of network-layer groups. In other words, for example, if one accelerator-node group comprises the accelerator nodes of m types, then all of the network layers of the neural network model are grouped into network-layer groups of the quantity m. According to the arrangement sequence of the accelerator nodes of the multiple types, each of the network-layer groups is deployed to one type of the accelerator nodes. In some embodiments, the network-layer sub-groups of that network-layer group may be deployed to the accelerator nodes of that type individually. The arrangement sequence of the accelerator nodes refers to the sequence of the communicative connection between the various accelerator nodes. As shown in FIG. 5, each of the accelerator-node groups comprises accelerator nodes of 3 types. All of the network layers of the neural network model are grouped sequentially into 3 network-layer groups, which are the phase block 1, the phase block 2 and the phase block 3. Regarding each of the accelerator-node groups, the phase block 1 is deployed to the accelerator nodes of the first type, i.e., the GPUs, the phase block 2 is deployed to the accelerator nodes of the second type, i.e., the MLUs, and the phase block 3 is deployed to the accelerator node of the third type, i.e., the XPU. In an embodiment, the step of grouping in advance all of the network layers of the neural network model into the plurality of network-layer groups may comprise:
based on internal memories and calculation powers of the types of the accelerator nodes of the accelerator-node groups, grouping all of the network layers of the neural network model into the plurality of network-layer groups.

It should be noted that, in practical applications, all of the network layers of the neural network model may be grouped according to the internal memory and the calculation power of each of the types of the accelerator nodes of the accelerator-node groups, to obtain the plurality of network-layer groups, so that each of the network-layer groups corresponds to one type of the accelerator nodes.

In some embodiments, in an embodiment of the present application, the layer quantities of the network-layer groups are in direct proportion to the internal memories and the calculation powers of the accelerator nodes of the corresponding types.

It can be understood that the size of the network-layer group that can be deployed in each of the types of the accelerator-node devices may be calculated according to the memory size of each of the accelerator nodes of each of the types of the accelerator nodes. If each of the accelerator nodes of that type has a higher internal memory, the network-layer group that can be deployed is larger. The network-layer groups of the quantity m may be expressed as {u_0,u_1, . . . ,u_m−1}. All of the network layers of the neural network model are grouped into network-layer groups of the quantity m, and each of the network-layer groups comprises at least one network-layer sub-group. One network-layer sub-group may comprise a plurality of channels, and may also comprise one channel, which may be decided according to practical situations, and is not particularly limited in the embodiments of the present application. In some embodiments, the size of each of the network-layer sub-groups may be determined according to the calculation powers and the internal memories of the different accelerator nodes, wherein if the calculation power of an accelerator node is higher, it is allocated more layers (or channels), and if its internal memory is higher, it is allocated more layers (or channels).

In an embodiment, the step of, according to the arrangement sequence of the accelerator nodes of the multiple types, deploying sequentially the network-layer groups to the accelerator nodes of the multiple types may comprise:
for the accelerator nodes of an i-th type, dividing in advance a corresponding i-th network-layer group into the network-layer sub-groups of a quantity nᵢ, wherein the accelerator nodes of the i-th type include the accelerator nodes of the quantity nᵢ, wherein nᵢ is an integer greater than 1, wherein i∈[0, m−1], wherein m represents a quantity of the types of the accelerator nodes; and
deploying the network-layer sub-groups of the quantity nᵢ to the accelerator nodes of the quantity nᵢ, wherein the network-layer sub-groups of the quantity nᵢ correspond to the accelerator nodes of the quantity nᵢ one to one.

It should be noted that, in practical applications, each of the accelerator-node groups of the distributed cluster comprises the accelerator nodes of m types, the neural network model is divided into network-layer groups of the quantity m, and the i-th network-layer group is deployed in the accelerator nodes of the i-th type. It will be described in detail in the embodiments of the present application how the i-th network-layer group is further subdivided to each of the accelerator nodes of the i-th type:

In some embodiments, the i-th network-layer group corresponding to the accelerator nodes of the i-th type may be divided in advance into network-layer sub-groups of the quantity nᵢ, which may comprise according to the accelerator nodes of the i-th type corresponding to the i-th network-layer group, enumerating network-layer-group grouping strategies of multiple types; subsequently for each of the types of the network-layer-group grouping strategies, calculating a corresponding execution duration of the network-layer-group grouping strategy in data processing; based on the execution durations corresponding to the network-layer-group grouping strategies individually, screening the network-layer-group grouping strategy the execution duration of which is lowest; and dividing the i-th network-layer group by using the network-layer-group grouping strategy the execution duration of which is lowest, to obtain the network-layer sub-groups of the quantity nᵢ.

It can be understood that, in the embodiments of the present application, the deployment and the parameter updating of the neural network model are realized based on the accelerator nodes of the different types, the communication between the nodes may be realized by using the method of multi-dimensional heterogeneous parallelism, and the final parallelism strategy of the multi-dimensional heterogeneous parallelism is to deploy the network-layer groups that have been completely grouped to the corresponding devices. Because the communication between the devices of the same type has a high efficiency, and does not have the problem of communication bottleneck, it is merely required to consider executing the grouping method of the highest efficiency, and by establishing the cost model and traversing the strategies for dynamic programming and solving, inquiring the most suitable network-layer-group grouping strategy between the devices of the same type.

In some embodiments, according to the quantity of the accelerator nodes in the accelerator nodes of the i-th type corresponding to the i-th network-layer group, all of the possible network-layer-group grouping strategies may be enumerated. For example, if one network-layer group comprises one network layer, and that network layer comprises 4 channels, then one network-layer-group grouping strategy is that the first two channels of the first layer are deployed at the first accelerator node, and the last two channels of the first layer are deployed at the second accelerator node. Another network-layer-group grouping strategy is that the first channel of the first layer is deployed at the first accelerator node, and the last three channels of the first layer are deployed at the second accelerator node. Another network-layer-group grouping strategy is that the first three channels of the first layer are deployed at the first accelerator node, and the last one channel of the first layer is deployed at the second accelerator node. All of the possible network-layer-group grouping strategies are enumerated likewise, so as to obtain the various network-layer-group grouping strategies with respect to the accelerator-node groups of the i-th type V={v_1,v_2, . . . ,v_p}, wherein v_1 to v_p represent the first type to the p-th type of the network-layer-group grouping strategies, and V represents the set of all of the network-layer-group grouping strategies. The constructed cost model is C-end_time-start_time, wherein end_time is the execution-ending time, and start_time is the execution-starting time. In other words, regarding each of the network-layer-group grouping strategies, it is caused to calculate and process the same inputted data, to calculate the execution durations corresponding to the network-layer-group grouping strategies. Subsequently, the set V may be traversed, and sequentially compared, to obtain the strategy that causes the execution duration C to be lowest. In other words,

$$v = {min}_{v ∈ V} C ,$$

to find out the network-layer-group grouping strategy v of the lowest execution duration C. Subsequently, the i-th network-layer group is divided by using the network-layer-group grouping strategy the execution duration of which is lowest, to obtain the network-layer sub-groups of the quantity nᵢ, and the network-layer sub-groups of the quantity nᵢ are deployed to the accelerator nodes of the quantity nᵢ, wherein each of the accelerator nodes corresponds to one network-layer sub-group.

In an embodiment, the step S120 of, based on the current calculation result, updating the current network parameter of the network-layer sub-group, to obtain the updated network parameter, to obtain the respective updated network parameters of all of the network-layer sub-groups of the neural network model comprises:
based on the current calculation result, updating the current network parameter of the network-layer sub-group, to obtain the updated network parameter;
in response to the current accelerator node being a last one node, obtaining the respective updated network parameters of the network-layer sub-groups of the neural network model; and
in response to the current accelerator node being not a last one node, sending the current calculation result to the accelerator node corresponding to the next one instance of the network-layer sub-groups, using the accelerator node corresponding to the next one network-layer sub-group as the current accelerator node, and returning to execute the step of, by using the network-layer sub-group deployed at the current accelerator node, calculating and processing the current to-be-processed datum.

It can be understood that, if the current accelerator node is the last one node, or, in other words, it is the accelerator node where the last one network-layer sub-group is deployed, that indicates that the network parameter in the last one network-layer sub-group has been completely updated. In other words, at this point, the updating of the network parameters of all of the network-layer sub-groups of the neural network model, after one time of the sample data inputting of the entire accelerator-node group, has been completed; in other words, one round of the network-parameter updating has been completed, whereby the updated network parameters corresponding individually to the network-layer sub-groups of the neural network model can be obtained. It should be noted that, in practical applications, the current to-be-processed datum that is received by the accelerator node where the first network-layer sub-group is deployed in the accelerator-node group is the sample datum, the current to-be-processed data that are received by the other accelerator nodes are the calculation results that are sent by the preceding accelerator nodes.

It should be noted that, regarding the current accelerator node, after the network-parameter updating of the corresponding network-layer sub-group has been completed, it may be further determined whether the current accelerator node is the node where the last one network-layer sub-group is deployed, i.e., determining whether, in this round of updating, all of the network-layer sub-groups have completed the updating of the network parameters. If the current accelerator node is not the node corresponding to the last one network-layer sub-group, that indicates that there is still a subsequent network-layer sub-group whose network parameter has not been updated. Accordingly, the method may comprise sending the current calculation result obtained by the current accelerator node to the accelerator node where the next one network-layer sub-group is deployed, subsequently using the current calculation result as the current to-be-processed datum of the next one accelerator node, subsequently using the next one accelerator node also as the current accelerator node, whereby the next one accelerator node calculates and processes the current to-be-processed datum that it receives, and obtains the corresponding calculation result, according to the calculation result, updating the network parameter of the network-layer sub-group deployed at the accelerator node, further determining whether the accelerator node is the accelerator node corresponding to the last one network-layer sub-group, and if no, then determining a new current accelerator node, and continuing to execute S110, till the network-parameter updating of the last one network-layer sub-group has been completed.

In an embodiment, the step of, in response to the current accelerator node being not the last one node, sending the current calculation result to the accelerator node corresponding to the next one instance of the network-layer sub-groups may comprise:
in response to the current accelerator node being not the last one node, determining whether the current accelerator node and the accelerator node corresponding to the next one network-layer sub-group are accelerator nodes of a same type;
in response to the current accelerator node and the accelerator node corresponding to the next one network-layer sub-group being accelerator nodes of the same type, in a mode of tensor parallelism, sending the current calculation result to the accelerator node corresponding to the next one network-layer sub-group; and
in response to the current accelerator node and the accelerator node corresponding to the next one network-layer sub-group being not accelerator nodes of the same type, in a mode of pipelined parallelism, sending the current calculation result to the accelerator node corresponding to the next one network-layer sub-group.

It should be noted that, regarding one accelerator-node group, because the accelerator-node group comprises accelerator nodes of multiple types, it is required to take into consideration the communication modes between the accelerator nodes of the same types and the communication modes between the accelerator nodes of the different types, so as to reach an optimum overall communication mode.

In some embodiments, in the embodiments of the present application, the accelerator nodes of the different types in the group may employ the mode of pipelined parallelism, so as to effectively alleviate the communication bottleneck between the heterogeneous devices, wherein the pipelined parallelism refers to allocating the layers of the neural network model to the different accelerator nodes. As shown in FIG. 6, regarding one accelerator-node group, it comprises, sequentially in the communication sequence, one XPU, one MLU and two GPUs. The three types of different accelerator nodes are deployed with the different layers of the model, and subsequently the communication duration is covered by node calculation and pipelined execution of the communication between the nodes, wherein the XPU is deployed with the first layer, the MLU is deployed with the second layer, one of the GPUs is deployed with part of the third layer and part of the fourth layer, and the other of the GPUs is deployed with the other part of the third layer and the other part of the fourth layer. The model parallelism between the accelerator nodes of the different types is in the mode of pipelined parallelism, and the model parallelism between the accelerator nodes of the same types is in the mode of tensor parallelism.

FIG. 7 shows a schematic diagram of the pipelined execution of the calculation and the communication between the nodes. Firstly, the inputted datum is divided into 3 parts (1, 2, and 3). The accelerator node XPU firstly calculates the part 1, and subsequently sends the calculation result obtained after the calculation of the part 1 to the accelerator node MLU (i.e., the XPU-MLU communication 1), and simultaneously the XPU starts calculating the part 2. The MLU, when has received the calculation result of the part 1 sent by the XPU, immediately starts executing the calculation of the part 1 (i.e., calculating the received calculation result corresponding to the part 1), and subsequently the MLU sends the calculation result obtained after the calculation of the part 1 to the next one device. Regarding the part 2 and the part 3 of the datum, the execution processes are the same. When the pipelining has been completed, the XPU is calculating the part 3, simultaneously the XPU-MLU is performing the communication of the part 2, and the MLU device is calculating the part 1.

The strategy of model parallelism (tensor parallelism) between the accelerator nodes of the same types in the group may sufficiently utilize the bandwidth, reduce the length of the pipeline, and reduce the traffic. In FIG. 7, the two GPUs employ the strategy of tensor parallelism, the different parts of the layer of the model are deployed to the different accelerator nodes, and the communication between the two GPUs is the PCIE communication, with a high communication efficiency, which may better increase the efficiency of the parameter updating, to increase the efficiency of the model training.

It should also be noted that, in the embodiments of the present application for the regrouping of the accelerator nodes, a multi-dimensional parallel-training strategy may be employed. The parallel-training strategy may effectively alleviate the communication bottleneck between the heterogeneous devices (i.e., the accelerator nodes of the different types), to increase the utilization ratio of the node devices and the efficiency of the model training.

In some embodiments, in the embodiments of the present application, the groups may be executed parallelly. As stated above, after the regrouping of the accelerator nodes, the accelerator-node groups are obtained, the accelerator-node groups have the same performances, and each of the groups can contain the entire model. Therefore, in the embodiments of the present application, the model training is performed in the mode of data parallelism between the groups, which may comprise firstly dividing all of the training-sample data (for example, historical-text data) into a plurality of batches; regarding each of the batches of the training-sample data, allocating that batch of the training-sample data evenly to all of the groups (as shown in FIG. 8), i.e., allocating the equal data size to each of the groups; and subsequently, for each of the groups separately, performing forward calculation and reverse calculation of the model, and, after the calculations have been completed, performing parameter aggregation and updating by interactive communication of the data between the groups.

In an embodiment, after the step of, based on the current calculation result, updating the current network parameter of the network-layer sub-group, to obtain the updated network parameter, the method may further comprise:
receiving the updated network parameters sent by other accelerator nodes corresponding to the network-layer sub-group in other instances of the accelerator-node groups;
based on the updated network parameters sent by the other accelerator nodes, adjusting the updated network parameter corresponding to the current accelerator node; and
sending the updated network parameter corresponding to the current accelerator node to target accelerator nodes corresponding to the network-layer sub-group in the other accelerator-node groups, whereby the target accelerator nodes, based on the updated network parameter corresponding to the current accelerator node, adjusts the updated network parameters of corresponding network-layer sub-groups.

It should be noted that, in the embodiments of the present application, in order to, in every round of the updating, enable the network parameters of all of the groups of the accelerator nodes to maintain the same, the method may comprise, regarding one accelerator-node group, regarding the current accelerator node, obtaining the current calculation result, and, based on the current calculation result, updating the current network parameter of the network-layer sub-group deployed at the current accelerator node; and after the updated network-layer parameter has been obtained, sending the updated network parameter corresponding to the network-layer sub-group in the current accelerator node to the target accelerator node where that network-layer sub-group is also deployed of the other groups, whereby the target accelerator node, according to the received updated network parameter, adjusts the updated network parameter in the corresponding network-layer sub-group.

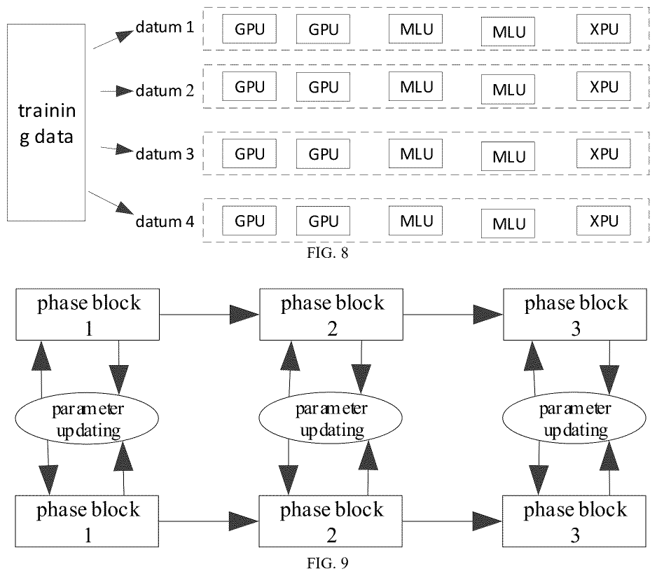

Correspondingly, the current accelerator node also receives the updated network parameters that are sent by the accelerator nodes where the same one network-layer sub-group is deployed of the other groups, and, according to the received updated network parameter, adjusts the updated network parameter of the network-layer sub-group in the current accelerator node. It can be understood that, because the accelerator nodes of the groups are totally the same, and the strategies of dividing the same one neural network model provided in all of the groups are totally the same, the model dividing strategies provided in the devices of the same type of all of the groups are the same, and the network-layer sub-groups that are deployed in the same accelerator nodes of the different groups are also the same. All of the GPUs of the different groups in FIG. 5 are deployed with the phase block 1, all of the MLUs are deployed with the phase block 2, and all of the XPUs are deployed with the phase block 3. In each of the groups the communication efficiency between the accelerator nodes of the same type is higher than the communication efficiency between the accelerator nodes of the different types. The parameter updating of the different network-layer sub-groups of the neural network model may be performed in the phase-block-independent mode, the parameters of the phase blocks of the model are independent of each other, and each of the phase blocks of the model, after the calculation has been completed, performs separate parameter updating. After the reverse calculation of the phase block 3 has been completed, the parameter updating of the phase block 3 is immediately performed, and it is not required to wait for the completion of the reverse calculation of the phase block 1 and subsequently update them together. The parameter updating in the phase-block-independent mode may increase the efficiency of the parameter updating, as shown in FIG. 9.

In an embodiment, in an embodiment of the present application, the total quantity of the accelerator nodes of the same type as the type of the current accelerator node in the accelerator-node group where the current accelerator node is located is at least 2. In other words, in one accelerator-node group, one type of the accelerator nodes has a plurality of accelerator nodes; for example, in FIG. 4, each of the groups has two GPUs and two MLUs.

Accordingly, correspondingly, the step of sending the updated network parameter corresponding to the current accelerator node to the target accelerator nodes corresponding to the network-layer sub-group in the other accelerator-node groups may comprise:
in response to the current accelerator node being a master accelerator node, acquiring the updated network parameter that is returned from a slave accelerator node of the same type as the type of the current accelerator node in the accelerator-node group where the current accelerator node is located, to obtain an updated-parameter set; and
sending the updated-parameter set to target master accelerator nodes corresponding to the network-layer sub-group in the other accelerator-node groups.

It should be noted that, in the embodiments of the present application, if, in one accelerator-node group, the accelerator nodes of the same type are two or more accelerator nodes, the master accelerator node may acquire the corresponding updated network parameters in the slave accelerator nodes, thereby realizing the aggregation of the network parameters, and based on the updated network parameters that are sent by the slave accelerator nodes and the updated network parameter in the accelerator node itself, obtain the updated-parameter set. Subsequently, the master accelerator node sends the updated-parameter set to target master accelerator nodes of the same type as the type of the present master accelerator node in the other accelerator-node groups, whereby the corresponding target master accelerator nodes in the other groups, after have received the updated-parameter set, based on the updated-parameter set, adjust the corresponding updated network parameters of the corresponding target master accelerator nodes, to obtain a network parameter that has been adjusted.

Correspondingly, if the current accelerator node is a master accelerator node, the current accelerator node receives the updated-parameter sets sent by other master accelerator nodes corresponding to the network-layer sub-group in the other accelerator-node groups, and subsequently, according to the received updated-parameter sets that are sent by the other master accelerator nodes, adjusts the updated network parameter corresponding to the current accelerator node, to obtain the network parameter that has been adjusted.

In some embodiments, because the updated-parameter sets that are sent by the other master accelerator nodes contain the updated network parameters of the corresponding master accelerator nodes, and also contain the updated network parameters of the slave accelerator nodes, the method may comprise, according to the updated-parameter sets that are sent by the other master accelerator nodes, determining parameter sets corresponding individually to the network layers of the network-layer sub-group in the current accelerator node; and subsequently for each of the network layers, according to the parameter sets corresponding to the network layers and the updated network parameters of the network layers in the current accelerator node, calculating the parameter average-value, and using the parameter average-value as the network parameter that has been adjusted corresponding to the network layer. All of the network layers execute those steps, so that all of the network parameters of all of the network layers in the network-layer sub-groups in the same accelerator nodes of the different groups can be the same, whereby, after each round of the updating has been completed, the network-layer parameters of the neural network models deployed at the accelerator-node groups can be the same.

In addition, regarding a main node as the current accelerator node, after the step of receiving the updated-parameter sets sent by the other master accelerator nodes corresponding to the network-layer sub-group in the other accelerator-node groups, the current accelerator node, among the updated-parameter sets sent by the other master accelerator nodes, determines an updated target parameter set corresponding to a slave accelerator node of the same type in the accelerator-node group where the current accelerator node is located; and subsequently sends the updated target parameter set to the corresponding slave accelerator node, whereby the slave accelerator nodes, according to the updated target parameter sets that they individually receive, adjust the updated network parameters in those slave accelerator nodes. The adjusting method also may comprise averaging all of the updated network parameters corresponding to the corresponding network layers, to obtain the parameter average-value, and using the parameter average-value as the adjusted network parameter.

In an embodiment, the total quantity of the accelerator nodes of the same type as the type of the current accelerator node in the accelerator-node group where the current accelerator node is located is at least 2. In other words, in one accelerator-node group, one type of the accelerator nodes has a plurality of accelerator nodes; for example, in FIG. 4, each of the groups has two GPUs and two MLUs.

Accordingly, correspondingly, the step of sending the updated network parameter corresponding to the current accelerator node to the target accelerator nodes corresponding to the network-layer sub-group in the other accelerator-node groups may comprise:
in response to the current accelerator node being a slave accelerator node, sending the updated network parameter corresponding to the current accelerator node to a master accelerator node corresponding to the current accelerator node in the accelerator-node group where the current accelerator node is located, whereby the master accelerator node, based on the updated network parameter corresponding to the current accelerator node, obtains the updated-parameter set, and sends the updated-parameter set to target master accelerator nodes corresponding to the network-layer sub-group in the other accelerator-node groups.

It should be noted that, in the embodiments of the present application, if, in one accelerator-node group, the accelerator nodes of the same type are two or more accelerator nodes, if the current accelerator node is a slave accelerator node, the updated network parameter in the slave accelerator node may be sent to the corresponding master accelerator node. The master accelerator node may acquire the corresponding updated network parameters in the slave accelerator nodes, thereby realizing the aggregation of the network parameters, and based on the updated network parameters that are sent by the slave accelerator nodes and the updated network parameter in the accelerator node itself, obtain the updated-parameter set. Subsequently, the master accelerator node sends the updated-parameter set to target master accelerator nodes of the same type as the type of the present master accelerator node in the other accelerator-node groups, whereby the corresponding target master accelerator nodes in the other groups, after have received the updated-parameter set, based on the updated-parameter set, adjust the corresponding updated network parameters of the corresponding target master accelerator nodes, to obtain the network parameter that has been adjusted.

Correspondingly, if the current accelerator node is a slave accelerator node, the current accelerator node receives the updated target parameter set sent by the master accelerator node corresponding to the current accelerator node, wherein the updated target parameter set is obtained by the master accelerator node according to the updated-parameter sets sent by other master accelerator nodes corresponding to the network-layer sub-group in the other accelerator-node groups. Subsequently, the current accelerator node, according to the updated target parameter set, adjusts the updated network parameter of each of the network layers in the network-layer sub-group in the current accelerator node, to obtain the network parameter that has been adjusted.

In some embodiments, after the updated target parameter set has been received, the method may comprise, according to the updated target parameter set, determining parameter sets corresponding individually to the network layers of the network-layer sub-group in the current accelerator node; and subsequently for each of the network layers, based on the parameter set corresponding to the network layer and by aggregating the current network parameters of the network layer, calculating the parameter average-value, and using the parameter average-value as the network parameter that has been adjusted corresponding to the network layer.

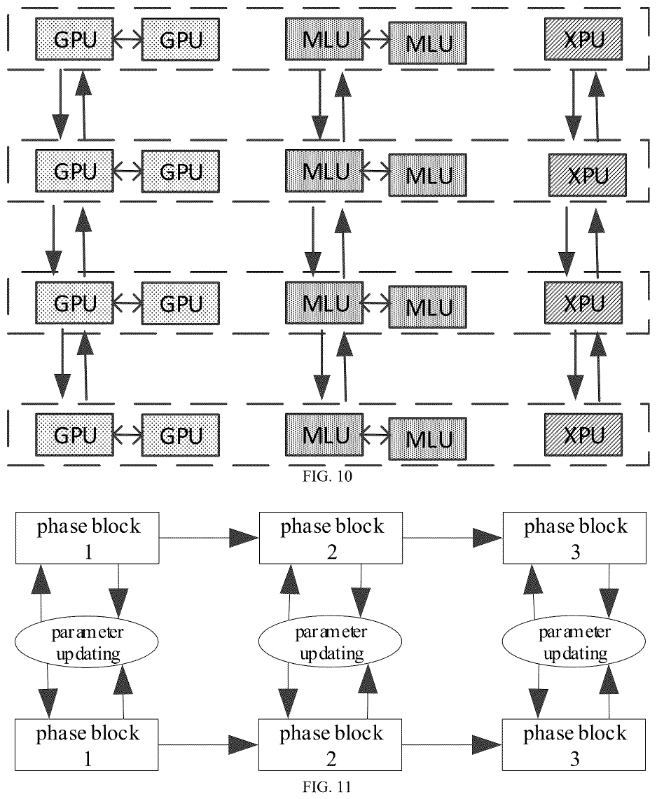

In other words, regarding each of the accelerator-node groups, firstly network-parameter aggregation is performed between the accelerator nodes of the same type in the group, to aggregate all of the network parameters to one accelerator node (i.e., the master accelerator node). The mode of the grouped aggregation and parallel communication between the accelerator nodes is shown in FIG. 10. Regarding the GPUs in FIG. 10, the two GPUs in the group firstly aggregate the updated network parameters to one of the GPUs (expressed as the main GPU), and subsequently the main GPUs of the different groups intercommunicate to perform the interaction and the adjustment of the network parameters. The parameter aggregation and updating of the main GPUs of the different groups are performed in the all-reduce (global reduction) mode, the main GPUs of the different groups are interconnected to form a ring-shaped structure (as shown in FIG. 11), and the network-parameter updating between the main GPUs is performed in the ring-allreduce (ring-shaped all-reduce) mode. The all-reduce mode is an operation that reduces the target arrays in all of programs (expressed as All) to a single array (expressed as Reduce) and returns the result array to all of the programs. The accelerator nodes of the different types perform the parameter aggregation and updating simultaneously with the asynchronous parallelism. After the parameter updating of the master accelerator node has been completed, it subsequently sends the corresponding updated-parameter set to the other accelerator nodes of the same type in the same one group. After the main GPUs of the different groups have completed the parameter updating, the main GPUs subsequently send the updated-parameter sets to the other GPUs, i.e., distributing to the other accelerator nodes of the same type in the same one group after the aggregation has been completed.

In practical applications, after all of the training-sample data have been completely executed, the final network parameters corresponding to the network layers of the pre-trained network model can be obtained. Subsequently, according to the final network parameters corresponding to the network layers, the neural network model that has been completely trained can be obtained. Further, the pre-trained network model that has been completely trained may be used to process a to-be-processed text, to obtain an outputted result.

It can be known from the above description that, after the division and the regrouping of the accelerator nodes, the embodiments of the present application provide a strategy of multi-dimensional heterogeneous parallelism suitable for a distributed cluster that has accelerator nodes of different types, wherein after the regrouping the accelerator nodes of the groups have the same performances, and the groups employ the mode of data parallelism. Because in a group exist accelerator nodes of multiple types, and the accelerator nodes have different performances, a combined strategy of model parallelism and pipelined parallelism is employed, to allocate the different parts of the model to the different accelerator nodes by using a certain strategy, wherein the accelerator nodes of lower performances bear smaller tasks. In the process of the model training, between the accelerator nodes of the same types merely the communication for the parameter updating is required, and between the accelerator nodes of the different types merely the transmission of the intermediate result data is required. The embodiments of the present application may effectively increase the efficiency of the training of neural network models (i.e., large-scale deep-learning models), increase the efficiency of multivariate heterogeneous calculation-power devices to the largest extent, and increase the performance of the training of neural network models. The present application, in usage, may sufficiently utilize the underlying hardware resource, and, by deploying multiple types of internal-memory resources in server platforms, support the tremendous demand on calculation power by neural network models and even ultra-large neural network models.

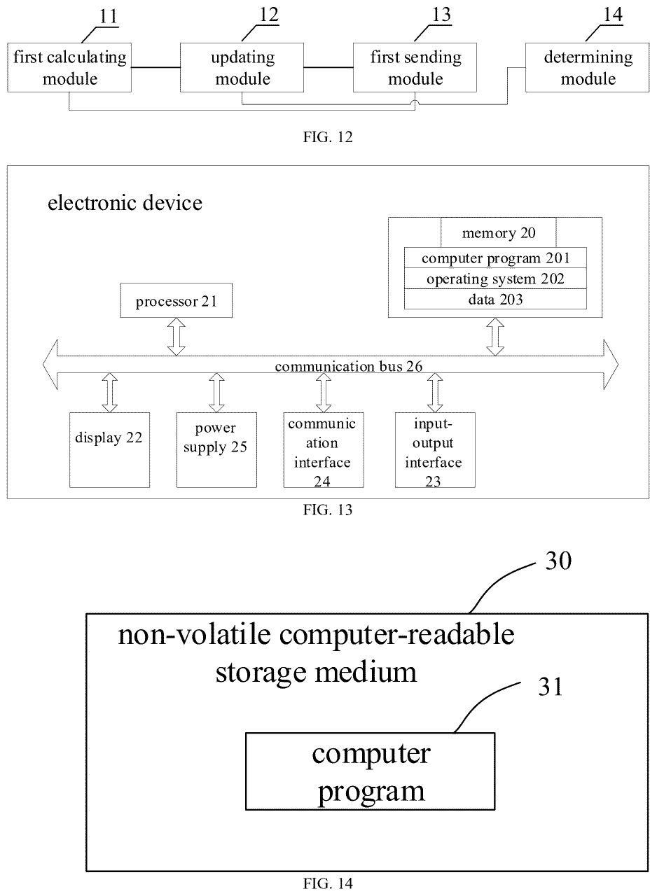

On the basis of the above embodiments, an embodiment of the present application further provides an apparatus of data processing for a distributed cluster, wherein the distributed cluster comprises a plurality of accelerator-node groups, each of the accelerator-node groups comprises accelerator nodes of multiple types, all of network layers of a neural network model are grouped into a plurality of network-layer sub-groups, each of the accelerator nodes is deployed with one instance of the network-layer sub-groups, and the apparatus is applied in any one of the accelerator nodes of the accelerator-node groups. Referring to FIG. 12, the apparatus comprises:
a first grouping module configured for grouping in advance the plurality of accelerator nodes of the distributed cluster, to obtain the plurality of accelerator-node groups, wherein for all of the accelerator-node groups the types and connection-arrangement modes of the accelerator nodes and quantities of the accelerator nodes of the same type are the same, and to-be-processed data that are received by first accelerator nodes of all of the accelerator-node groups are different;
a first calculating module 11 configured for, by using the network-layer sub-group deployed at a current accelerator node, calculating and processing a current to-be-processed datum, to obtain a current calculation result; and
an updating module 12 configured for, based on the current calculation result, updating a current network parameter of the network-layer sub-group, to obtain an updated network parameter, to obtain respective updated network parameters of all of the network-layer sub-groups of the neural network model.

In an embodiment, the first grouping module comprises:
a first grouping unit configured for dividing the accelerator nodes of each of the types of the distributed cluster individually evenly into a preset group quantity; and
a regrouping unit configured for regrouping the different types of accelerator nodes of the preset group quantity, to form the plurality of accelerator-node groups, wherein each of the accelerator-node groups comprises all of the types of accelerator nodes.

In an embodiment, the apparatus further comprises:
a first calculating unit configured for, based on a memory size occupied by the neural network model and a total memory size of all of the accelerator nodes of the distributed cluster, calculating to obtain the preset group quantity of the division.

In an embodiment, the first calculating unit comprises:
a first acquiring subunit configured for acquiring the memory size occupied by the neural network model;
a first calculating subunit configured for, according to memory sizes of the accelerator nodes of the distributed cluster, calculating the total memory size of the accelerator nodes; and
a second calculating subunit configured for dividing the total memory size by the memory size occupied by the neural network model, and rounding a quotient value, to obtain the preset group quantity.

In an embodiment, the apparatus further comprises:
a second grouping module configured for grouping in advance all of the network layers of the neural network model into a plurality of network-layer groups, wherein each of the network-layer groups comprises at least one instance of the network-layer sub-groups, and a quantity of the network-layer groups is equal to a quantity of the types of the accelerator nodes of each of the accelerator-node groups; and
a deploying module configured for, for each of the accelerator-node groups, according to an arrangement sequence of the accelerator nodes of the multiple types, deploying sequentially the network-layer groups to the accelerator nodes of the multiple types, wherein each of the types of the accelerator nodes corresponds to one instance of the network-layer groups, and each of the accelerator nodes corresponds to one instance of the network-layer sub-groups.

In an embodiment, the second grouping module is configured for:
based on internal memories and calculation powers of the types of the accelerator nodes of the accelerator-node groups, grouping all of the network layers of the neural network model into the plurality of network-layer groups.

In an embodiment, layer quantities of the network-layer groups are in direct proportion to the internal memories and the calculation powers of the accelerator nodes of the corresponding types.

In an embodiment, the deploying module comprises:
a second grouping unit configured for, for the accelerator nodes of an i-th type, dividing in advance a corresponding i-th network-layer group into the network-layer sub-groups of a quantity nᵢ, wherein the accelerator nodes of the i-th type include the accelerator nodes of the quantity nᵢ, wherein nᵢ is an integer greater than 1, wherein i∈[0, m−1], wherein m represents a quantity of the types of the accelerator nodes; and
a deploying unit configured for deploying the network-layer sub-groups of the quantity nᵢ to the accelerator nodes of the quantity nᵢ, wherein the network-layer sub-groups of the quantity nᵢ correspond to the accelerator nodes of the quantity nᵢ one to one.

In an embodiment, the second grouping unit comprises:
a strategy generating subunit configured for, according to the accelerator nodes of the i-th type corresponding to the i-th network-layer group, enumerating network-layer-group grouping strategies of multiple types;
a third calculating subunit configured for, for each of the types of the network-layer-group grouping strategies, calculating a corresponding execution duration of the network-layer-group grouping strategy in data processing;
a screening subunit configured for, based on the execution durations corresponding to the network-layer-group grouping strategies individually, screening the network-layer-group grouping strategy the execution duration of which is lowest; and
a dividing subunit configured for dividing the i-th network-layer group by using the network-layer-group grouping strategy the execution duration of which is lowest, to obtain the network-layer sub-groups of the quantity nᵢ.

In an embodiment, the updating module comprises:
an updating unit configured for, based on the current calculation result, updating the current network parameter of the network-layer sub-group, to obtain the updated network parameter;
a deciding unit configured for, in response to the current accelerator node being a last one node, obtaining the respective updated network parameters of the network-layer sub-groups of the neural network model; and
a first sending unit configured for, in response to the current accelerator node being not a last one node, sending the current calculation result to the accelerator node corresponding to the next one instance of the network-layer sub-groups, using the accelerator node corresponding to the next one network-layer sub-group as the current accelerator node, and returning to execute the step of, by using the network-layer sub-group deployed at the current accelerator node, calculating and processing the current to-be-processed datum.

In an embodiment, the first sending unit comprises:
a judging subunit configured for, if the accelerator node is not the last one node, determining whether the accelerator node and the accelerator node corresponding to the next one network layer are accelerator nodes of the same type; if the accelerator node and the accelerator node corresponding to the next one network layer are accelerator nodes of the same type, triggering a first sending subunit; and if the accelerator node and the accelerator node corresponding to the next one network layer are not accelerator nodes of the same type, triggering a second sending subunit;
the first sending subunit is configured for, in a mode of tensor parallelism, sending the current calculation result to the accelerator node corresponding to the next one network layer; and
the second sending subunit is configured for, in a mode of pipelined parallelism, sending the current calculation result to the accelerator node corresponding to the next one network layer.

In an embodiment, the apparatus further comprises:
a receiving module configured for receiving the updated network parameters sent by other accelerator nodes corresponding to the network-layer sub-group in other instances of the accelerator-node groups;
a first adjusting module configured for, based on the updated network parameters sent by the other accelerator nodes, adjusting the updated network parameter corresponding to the current accelerator node; and
a first sending module 13 configured for sending the updated network parameter corresponding to the current accelerator node to target accelerator nodes corresponding to the network-layer sub-group in the other accelerator-node groups, whereby the target accelerator nodes, based on the updated network parameter corresponding to the current accelerator node, adjusts the updated network parameters of corresponding network-layer sub-groups.

In an embodiment, a total quantity of the accelerator nodes of a same type as a type of the current accelerator node in the accelerator-node group where the current accelerator node is located is at least 2; and
the first sending module 13 comprises:
a first acquiring unit configured for, in response to the current accelerator node being a master accelerator node, acquiring the updated network parameter that is returned from a slave accelerator node of the same type as the type of the current accelerator node in the accelerator-node group where the current accelerator node is located, to obtain an updated-parameter set; and
a second sending unit configured for sending the updated-parameter set to target master accelerator nodes corresponding to the network-layer sub-group in the other accelerator-node groups.

In an embodiment, the receiving module comprises:
a first receiving subunit configured for, in response to the current accelerator node being a master accelerator node, receiving the updated-parameter sets sent by other master accelerator nodes corresponding to the network-layer sub-group in the other accelerator-node groups; and
the first adjusting module is configured for:
based on the updated-parameter sets sent by the other master accelerator nodes, adjusting the updated network parameter corresponding to the current accelerator node, to obtain a network parameter that has been adjusted.

In an embodiment, the first adjusting module comprises:
a first determining unit configured for, based on the updated-parameter sets sent by the other master accelerator nodes, determining parameter sets corresponding individually to the network layers of the network-layer sub-group in the current accelerator node; and
a second calculating unit configured for, for each of the network layers, based on the parameter set corresponding to the network layer, calculating a parameter average-value, and using the parameter average-value as the network parameter that has been adjusted corresponding to the network layer.

In an embodiment, the apparatus further comprises:
a second determining unit configured for, among the updated-parameter sets sent by the other master accelerator nodes, determining an updated target parameter set corresponding to a slave accelerator node of the same type in the accelerator-node group where the current accelerator node is located; and
a third sending unit configured for sending the updated target parameter set to the corresponding slave accelerator node, whereby the slave accelerator node, according to the updated target parameter set, adjusts the updated network parameter in the slave accelerator node.

In an embodiment, a total quantity of the accelerator nodes of a same type as a type of the current accelerator node in the accelerator-node group where the current accelerator node is located is at least 2; and the first sending module 13 is configured for:
in response to the current accelerator node being a slave accelerator node, sending the updated network parameter corresponding to the current accelerator node to a master accelerator node corresponding to the current accelerator node in the accelerator-node group where the current accelerator node is located, whereby the master accelerator node, based on the updated network parameter corresponding to the current accelerator node, obtains the updated-parameter set, and sends the updated-parameter set to target master accelerator nodes corresponding to the network-layer sub-group in the other accelerator-node groups.

In an embodiment, the receiving module comprises:
a second receiving unit configured for, in response to the current accelerator node being a slave accelerator node, receiving the updated target parameter set sent by the master accelerator node corresponding to the current accelerator node, wherein the updated target parameter set is obtained by the master accelerator node according to the updated-parameter sets sent by other master accelerator nodes corresponding to the network-layer sub-group in the other accelerator-node groups; and
an adjusting unit configured for, based on the updated target parameter set, adjusting the updated network parameters of the network layers in the network-layer sub-group in the current accelerator node, to obtain network parameters that have been adjusted.

In an embodiment, the adjusting unit comprises:
a determining subunit configured for, based on the updated target parameter set, determining parameter sets corresponding individually to the network layers of the network-layer sub-group in the current accelerator node; and
a fourth calculating subunit configured for, for each of the network layers, based on the parameter set corresponding to the network layer, calculating a parameter average-value, and using the parameter average-value as the network parameter that has been adjusted corresponding to the network layer.

It should be noted that the apparatus of data processing for a distributed cluster according to the embodiments of the present application has the advantageous effects the same as those of the method of data processing for a distributed cluster according to the above embodiments, and the description on the method of data processing for a distributed cluster according to the embodiments of the present application may refer to the above embodiments, and is not discussed further in the embodiments of the present application.

On the basis of the above embodiments, an embodiment of the present application provides a system of data processing for a distributed cluster, wherein the distributed cluster comprises a plurality of accelerator-node groups, each of the accelerator-node groups comprises accelerator nodes of multiple types, all of network layers of a neural network model are grouped into a plurality of network-layer sub-groups, each of the accelerator nodes is deployed with one instance of the network-layer sub-groups, and any one of the accelerator nodes comprises:
a memory 20 configured for storing a computer program; and
a processor 21 configured for, when executing the computer program, implementing the steps of the method of data processing for a distributed cluster described above.

In some embodiments, the accelerator node according to the embodiments of the present application is shown in FIG. 13. The accelerator node may be an electronic device. The electronic device according to the present embodiment may include but is not limited to a smartphone, a tablet personal computer, a notebook computer and a desktop computer.

The processor 21 may comprise one or more processing cores, for example, a 4-core processor and an 8-core processor. The processor 21 may be embodied in at least one of the hardware forms of DSP (Digital Signal Processing), FPGA (Field-Programmable Gate Array) and PLA (Programmable Logic Array). The processor 21 may also comprise a host processor and a co-processor. The host processor refers to a processor configured for processing the data in the awakening state, and is also referred to as a CPU (Central Processing Unit). The co-processor refers to a low-power-consumption processor configured for processing the data in the standby state. In some embodiments, the processor 21 may be integrated with a GPU (Graphics Processing Unit), wherein the GPU is configured for rendering and drawing the contents that the display screen is required to display. In some embodiments, the processor 21 may further comprise an AI (Artificial Intelligence) processor, wherein the AI processor is configured for processing the calculating operations related to machine learning.

The memory 20 may comprise one or more non-volatile computer-readable storage mediums, wherein the non-volatile computer-readable storage mediums may be non-transient. The memory 20 may further comprise a high-speed random access memory and a non-volatile memory, for example, one or more magnetic-disk storage devices and flash-memory storage devices. In the present embodiment, the memory 20 is at least configured for storing the following computer program 201, wherein the computer program, after loaded and executed by the processor 21, can implement the relevant steps of the method of data processing for a distributed cluster according to any one of the above embodiments. Additionally, the resources stored by the memory 20 may further comprise an operating system 202, data 203 and so on, wherein the storage mode may be short-term storage or permanent storage. The operating system 202 may include Windows, Unix, Linux and so on. The data 203 may include but are not limited to a set deviation amount.

In some embodiments, the electronic device may further comprise a display screen 22, an input-output interface 23, a communication interface 24, a power supply 25 and a communication bus 26.

A person skilled in the art can understand that the structure shown in FIG. 13 does not limit the electronic device, and the electronic device may comprise components more or fewer than those illustrated.

It can be understood that the method of data processing for a distributed cluster according to the above embodiments, if embodied in the form of software function units and sold or used as an independent product, may be stored in a non-volatile computer-readable storage medium. On the basis of such a comprehension, the substance of the technical solutions of the present application, or the part thereof that makes a contribution over the related art, or the whole or part of the technical solutions, may be embodied in the form of a software product. The computer software product is stored in a non-volatile readable storage medium, and implements all or some of the steps of the methods according to the embodiments of the present application. Moreover, the non-volatile readable storage medium includes various non-volatile readable storage media that can store a program code, such as a USB flash disk, a mobile hard disk drive, a Read-Only Memory (ROM), a Random Access Memory (RAM), an Electrically Erasable Programmable ROM, a register, a hard disk, a movable magnetic disk, a CD-ROM, a diskette and an optical disk.

On that basis, as shown in FIG. 14, an embodiment of the present application further provides a non-volatile computer-readable storage medium, wherein the non-volatile computer-readable storage medium 30 stores a computer program 31, and the computer program 31, when executed by a processor, implements the steps of the method of data processing for a distributed cluster described above.

The embodiments of the description are described in the mode of progression, each of the embodiments emphatically describes the differences from the other embodiments, and the same or similar parts of the embodiments may refer to each other. Regarding the devices according to the embodiments, because they correspond to the methods according to the embodiments, they are described simply, and the relevant parts may refer to the description on the methods.

It should also be noted that, in the description, relation terms such as first and second are merely intended to distinguish one entity or operation from another entity or operation, and that does not necessarily require or imply that those entities or operations have therebetween any such actual relation or order. Furthermore, the terms “include”, “comprise” or any variants thereof are intended to cover non-exclusive inclusions, so that processes, methods, articles or devices that include a series of elements do not only include those elements, but also include other elements that are not explicitly listed, or include the elements that are inherent to such processes, methods, articles or devices. Unless further limitation is set forth, an element defined by the wording “comprising a . . . ” does not exclude additional same element in the process, method, article or device comprising the element.

A person skilled in the art can further understand that the units and the algorithm steps of the examples described with reference to the embodiments disclosed herein may be implemented by using electronic hardware, computer software or a combination thereof. In order to clearly explain the interchangeability between the hardware and the software, the above description has described generally the configurations and the steps of the examples according to the functions. Whether those functions are executed by hardware or software depends on the particular applications and the design constraints of the technical solutions. A person skilled in the art may employ different methods to implement the described functions with respect to each of the particular applications, but the implementations should not be considered as extending beyond the scope of the present application.

The steps of the method or algorithm described with reference to the embodiments disclosed herein may be implemented directly by using hardware, a software module executed by a processor or a combination thereof. The software module may be embedded in a Random Access Memory (RAM), an internal memory, a read-only memory (ROM), an electrically programmable ROM, an electrically erasable programmable ROM, a register, a hard disk, a removable disk, a CD-ROM, or a non-volatile readable storage medium in any other form well known in the art.

The above description on the disclosed embodiments enables a person skilled in the art to implement or use the present application. Various modifications on those embodiments will be apparent to a person skilled in the art, and the general principle defined herein may be implemented in other embodiments without departing from the spirit or scope of the present application. Therefore, the present application should not be limited to the embodiments illustrated herein, but should meet the broadest scope in accord with the principle and the novel characteristics disclosed herein.

1. A method of data processing for a distributed cluster, wherein the distributed cluster comprises a plurality of accelerator-node groups, each of the accelerator-node groups comprises accelerator nodes of multiple types, all of network layers of a neural network model are grouped into a plurality of network-layer sub-groups, each of the accelerator nodes is deployed with one instance of the network-layer sub-groups, and the method is applied in any one of the accelerator nodes of the accelerator-node groups, and comprises:
grouping in advance the plurality of accelerator nodes of the distributed cluster, to obtain the plurality of accelerator-node groups, wherein for all of the accelerator-node groups the types and connection-arrangement modes of the accelerator nodes and quantities of the accelerator nodes of the same type are the same, and to-be-processed data that are received by first accelerator nodes of all of the accelerator-node groups are different;
by using the network-layer sub-group deployed at a current accelerator node, calculating and processing a current to-be-processed datum, to obtain a current calculation result; and
based on the current calculation result, updating a current network parameter of the network-layer sub-group, to obtain an updated network parameter, to obtain respective updated network parameters of all of the network-layer sub-groups of the neural network model.

2. The method of data processing for a distributed cluster according to claim 1, wherein the step of grouping in advance the plurality of accelerator nodes of the distributed cluster, to obtain the plurality of accelerator-node groups comprises:
dividing the accelerator nodes of each of the types of the distributed cluster individually evenly into a preset group quantity; and
regrouping the different types of accelerator nodes of the preset group quantity, to form the plurality of accelerator-node groups, wherein each of the accelerator-node groups comprises all of the types of accelerator nodes.

3. The method of data processing for a distributed cluster according to claim 2, wherein before the step of dividing the accelerator nodes of each of the types of the distributed cluster individually evenly into the preset group quantity, the method further comprises:
based on a memory size occupied by the neural network model and a total memory size of all of the accelerator nodes of the distributed cluster, calculating to obtain the preset group quantity of the division.

4. The method of data processing for a distributed cluster according to claim 3, wherein the step of, based on the memory size occupied by the neural network model and the total memory size of all of the accelerator nodes of the distributed cluster, calculating to obtain the preset group quantity of the division comprises:
acquiring the memory size occupied by the neural network model;
according to memory sizes of the accelerator nodes of the distributed cluster, calculating the total memory size of the accelerator nodes; and
dividing the total memory size by the memory size occupied by the neural network model, and rounding a quotient value, to obtain the preset group quantity.

5. The method of data processing for a distributed cluster according to claim 1, wherein the method further comprises:
grouping in advance all of the network layers of the neural network model into a plurality of network-layer groups, wherein each of the network-layer groups comprises at least one instance of the network-layer sub-groups, and a quantity of the network-layer groups is equal to a quantity of the types of the accelerator nodes of each of the accelerator-node groups; and
for each of the accelerator-node groups, according to an arrangement sequence of the accelerator nodes of the multiple types, deploying sequentially the network-layer groups to the accelerator nodes of the multiple types, wherein each of the types of the accelerator nodes corresponds to one instance of the network-layer groups, and each of the accelerator nodes corresponds to one instance of the network-layer sub-groups.

6. The method of data processing for a distributed cluster according to claim 5, wherein the step of grouping in advance all of the network layers of the neural network model into the plurality of network-layer groups comprises:
based on internal memories and calculation powers of the types of the accelerator nodes of the accelerator-node groups, grouping all of the network layers of the neural network model into the plurality of network-layer groups.

7. The method of data processing for a distributed cluster according to claim 6, wherein layer quantities of the network-layer groups are in direct proportion to the internal memories and the calculation powers of the accelerator nodes of the corresponding types.

8. The method of data processing for a distributed cluster according to claim 5, wherein the step of, according to the arrangement sequence of the accelerator nodes of the multiple types, deploying sequentially the network-layer groups to the accelerator nodes of the multiple types comprises:
for the accelerator nodes of an i-th type, dividing in advance a corresponding i-th network-layer group into the network-layer sub-groups of a quantity nᵢ, wherein the accelerator nodes of the i-th type include the accelerator nodes of the quantity nᵢ, wherein nᵢ is an integer greater than 1, wherein i∈[0, m−1], wherein m represents a quantity of the types of the accelerator nodes; and
deploying the network-layer sub-groups of the quantity nᵢ to the accelerator nodes of the quantity nᵢ, wherein the network-layer sub-groups of the quantity nᵢ correspond to the accelerator nodes of the quantity nᵢ one to one.

9. The method of data processing for a distributed cluster according to claim 8, wherein the step of dividing in advance the corresponding i-th network-layer group into the network-layer sub-groups of the quantity nᵢ comprises:
according to the accelerator nodes of the i-th type corresponding to the i-th network-layer group, enumerating network-layer-group grouping strategies of multiple types;
for each of the types of the network-layer-group grouping strategies, calculating a corresponding execution duration of the network-layer-group grouping strategy in data processing;
based on the execution durations corresponding to the network-layer-group grouping strategies individually, screening the network-layer-group grouping strategy the execution duration of which is lowest; and
dividing the i-th network-layer group by using the network-layer-group grouping strategy the execution duration of which is lowest, to obtain the network-layer sub-groups of the quantity nᵢ.

10. The method of data processing for a distributed cluster according to claim 1, wherein the step of, based on the current calculation result, updating the current network parameter of the network-layer sub-group, to obtain the updated network parameter, to obtain the respective updated network parameters of all of the network-layer sub-groups of the neural network model comprises:
based on the current calculation result, updating the current network parameter of the network-layer sub-group, to obtain the updated network parameter;
in response to the current accelerator node being a last one node, obtaining the respective updated network parameters of the network-layer sub-groups of the neural network model; and
in response to the current accelerator node being not a last one node, sending the current calculation result to the accelerator node corresponding to the next one instance of the network-layer sub-groups, using the accelerator node corresponding to the next one network-layer sub-group as the current accelerator node, and returning to execute the step of, by using the network-layer sub-group deployed at the current accelerator node, calculating and processing the current to-be-processed datum.

11. The method of data processing for a distributed cluster according to claim 10, wherein the step of, in response to the current accelerator node being not the last one node, sending the current calculation result to the accelerator node corresponding to the next one instance of the network-layer sub-groups comprises:
in response to the current accelerator node being not the last one node, determining whether the current accelerator node and the accelerator node corresponding to the next one network-layer sub-group are accelerator nodes of a same type;
in response to the current accelerator node and the accelerator node corresponding to the next one network-layer sub-group being accelerator nodes of the same type, in a mode of tensor parallelism, sending the current calculation result to the accelerator node corresponding to the next one network-layer sub-group; and
in response to the current accelerator node and the accelerator node corresponding to the next one network-layer sub-group being not accelerator nodes of the same type, in a mode of pipelined parallelism, sending the current calculation result to the accelerator node corresponding to the next one network-layer sub-group.

12. The method of data processing for a distributed cluster according to claim 1, wherein after the step of, based on the current calculation result, updating the current network parameter of the network-layer sub-group, to obtain the updated network parameter, the method further comprises:
receiving the updated network parameters sent by other accelerator nodes corresponding to the network-layer sub-group in other instances of the accelerator-node groups;
based on the updated network parameters sent by the other accelerator nodes, adjusting the updated network parameter corresponding to the current accelerator node; and
sending the updated network parameter corresponding to the current accelerator node to target accelerator nodes corresponding to the network-layer sub-group in the other accelerator-node groups, whereby the target accelerator nodes, based on the updated network parameter corresponding to the current accelerator node, adjusts the updated network parameters of corresponding network-layer sub-groups.

13. The method of data processing for a distributed cluster according to claim 12, wherein a total quantity of the accelerator nodes of a same type as a type of the current accelerator node in the accelerator-node group where the current accelerator node is located is at least 2; and
the step of sending the updated network parameter corresponding to the current accelerator node to the target accelerator nodes corresponding to the network-layer sub-group in the other accelerator-node groups comprises:
in response to the current accelerator node being a master accelerator node, acquiring the updated network parameter that is returned from a slave accelerator node of the same type as the type of the current accelerator node in the accelerator-node group where the current accelerator node is located, to obtain an updated-parameter set; and
sending the updated-parameter set to target master accelerator nodes corresponding to the network-layer sub-group in the other accelerator-node groups.

14. The method of data processing for a distributed cluster according to claim 13, wherein the step of receiving the updated network parameters sent by the other accelerator nodes corresponding to the network-layer sub-group in the other instances of the accelerator-node groups comprises:
in response to the current accelerator node being a master accelerator node, receiving the updated-parameter sets sent by other master accelerator nodes corresponding to the network-layer sub-group in the other accelerator-node groups; and
the step of, based on the updated network parameters sent by the other accelerator nodes, adjusting the updated network parameter corresponding to the current accelerator node comprises:
based on the updated-parameter sets sent by the other master accelerator nodes, adjusting the updated network parameter corresponding to the current accelerator node, to obtain a network parameter that has been adjusted.

15. The method of data processing for a distributed cluster according to claim 14, wherein the step of, based on the updated-parameter sets sent by the other master accelerator nodes, adjusting the updated network parameter corresponding to the current accelerator node, to obtain the network parameter that has been adjusted comprises:
based on the updated-parameter sets sent by the other master accelerator nodes, determining parameter sets corresponding individually to the network layers of the network-layer sub-group in the current accelerator node; and
for each of the network layers, based on the parameter set corresponding to the network layer, calculating a parameter average-value, and using the parameter average-value as the network parameter that has been adjusted corresponding to the network layer.

16. The method of data processing for a distributed cluster according to claim 14, wherein after the step of receiving the updated-parameter sets sent by the other master accelerator nodes corresponding to the network-layer sub-group in the other accelerator-node groups, the method further comprises:
among the updated-parameter sets sent by the other master accelerator nodes, determining an updated target parameter set corresponding to a slave accelerator node of the same type in the accelerator-node group where the current accelerator node is located; and
sending the updated target parameter set to the corresponding slave accelerator node, whereby the slave accelerator node, according to the updated target parameter set, adjusts the updated network parameter in the slave accelerator node.

17. The method of data processing for a distributed cluster according to claim 12, wherein a total quantity of the accelerator nodes of a same type as a type of the current accelerator node in the accelerator-node group where the current accelerator node is located is at least 2; and
the step of sending the updated network parameter corresponding to the current accelerator node to the target accelerator nodes corresponding to the network-layer sub-group in the other accelerator-node groups comprises:
in response to the current accelerator node being a slave accelerator node, sending the updated network parameter corresponding to the current accelerator node to a master accelerator node corresponding to the current accelerator node in the accelerator-node group where the current accelerator node is located, whereby the master accelerator node, based on the updated network parameter corresponding to the current accelerator node, obtains the updated-parameter set, and sends the updated-parameter set to target master accelerator nodes corresponding to the network-layer sub-group in the other accelerator-node groups.

18. The method of data processing for a distributed cluster according to claim 17, wherein the step of receiving the updated network parameters sent by the other accelerator nodes corresponding to the network-layer sub-group in the other instances of the accelerator-node groups comprises:
in response to the current accelerator node being a slave accelerator node, receiving the updated target parameter set sent by the master accelerator node corresponding to the current accelerator node, wherein the updated target parameter set is obtained by the master accelerator node according to the updated-parameter sets sent by other master accelerator nodes corresponding to the network-layer sub-group in the other accelerator-node groups; and
based on the updated target parameter set, adjusting the updated network parameters of the network layers in the network-layer sub-group in the current accelerator node, to obtain network parameters that have been adjusted.

19. (canceled)

20. (canceled)

21. A system of data processing for a distributed cluster, wherein the distributed cluster comprises a plurality of accelerator-node groups, each of the accelerator-node groups comprises accelerator nodes of multiple types, all of network layers of a neural network model are grouped into a plurality of network-layer sub-groups, each of the accelerator nodes is deployed with one instance of the network-layer sub-groups, and any one of the accelerator nodes comprises:
a memory configured for storing a computer program; and
a processor configured for, when executing the computer program, implementing the steps of the method of data processing for a distributed cluster according to claim 1.

22. A non-transitory computer-readable storage medium, wherein the non-transitory computer-readable storage medium stores a computer program, and the computer program, when executed by a processor, implements the steps of the method of data processing for a distributed cluster according to claim 1.
